(19) United States
(12) Patent Application Publication
(10) Pub. No.: US 2025/0237254 A1
(43) Pub. Date: Jul. 24, 2025

(54) SYSTEM FOR CONNECTING AN ACCESSORY TO AN ITEM

(71) Applicant: BOMBARDIER RECREATIONAL PRODUCTS INC., Valcourt (CA)

(72) Inventors: Philippe BELANGER-BARIL, Bromont (CA); Louis DUMOULIN, Marieville (CA); Kaj HALLGRIMSSON, Bromont (CA); Michael ROY, Racine (CA); Alexandre MORIN-SAVARD, Drummondville (CA); Laurent SAVARD, Granby (CA); Nabil GUENDOUL, Granby (CA); Louis-Charles GINGRAS, Rougemont (CA)

(21) Appl. No.: 18/852,673

(22) PCT Filed: Mar. 31, 2023
(86) PCT No.: PCT/IB2023/053274

§ 371 Date: Sep. 30, 2024

Related U.S. Application Data
(60) Provisional application No. 63/326,123, filed on Mar. 31, 2022.

(51) Int. Cl. F16B 21/02; B62J 11/00

(52) U.S. Cl. CPC F16B 21/02; B62J 11/00

(57) ABSTRACT

A system for connecting an accessory to an item, the system including an anchor fixture including a fixture body and the anchor aperture having at least one recessed portion along an edge thereof; and an anchor with an anchor lock being configured to be inserted through the anchor aperture of the anchor fixture, the anchor lock having at least one protrusion extending therefrom, the at least one protrusion of the anchor lock being received in the at least one recessed portion of the anchor aperture; and the anchor being selectively secured to the anchor fixture by inserting the anchor lock through the anchor aperture and moving the anchor lock relative to the anchor fixture to place the anchor lock in the locked position, the anchor lock impeding movement within the anchor fixture of the anchor.

### CROSS-REFERENCE

The present application claims priority to U.S. Provisional Patent Application No. 63/326,123, entitled “SYSTEM FOR CONNECTING AN ACCESSORY TO AN ITEM,” filed on Mar. 31, 2022, the entirety of which is incorporated by reference herein.

### FIELD OF THE TECHNOLOGY

The present invention relates to systems and methods for attachment of accessories to a vehicle.

### BACKGROUND

Vehicles such as snowmobiles are often made to carry miscellaneous accessories for personal items, fuel, equipment, amongst others, in addition to passengers. For instance, the vehicles may be provided with racks and the like to carry cargo. The cargo items are often secured to parts of the vehicles by ropes, cords, tie-downs and the like. Anchoring systems including an anchor and an anchor fixture are also available to easily secure accessories to a vehicle. However, these solutions are often not easy to implement for smaller accessories that a driver of a vehicle may desire to keep on hand (e.g., a walkie-talkie).

Therefore, there is a desire for a system for connecting an accessory to an item that at least partly addresses these drawbacks.

### SUMMARY

It is an object of the present invention to ameliorate at least some of the inconveniences present in the prior art.

According to an aspect of the present technology, there is provided a system for connecting an accessory to an item, the system comprising an anchor fixture comprising a fixture body configured to be connected to one of the accessory and the item, the fixture body defining an anchor aperture therein, the anchor aperture having at least one recessed portion along an edge thereof; an anchor configured to be connected to an other one of the accessory and the item, the anchor lock being configured to be inserted through the anchor aperture of the anchor fixture, the anchor lock having at least one protrusion extending therefrom, the anchor lock being movable relative to the anchor fixture between an unlocked position and a locked position, in the unlocked position, the anchor lock being free to pass through the anchor aperture, and in the locked position: the anchor lock being prevented by the anchor fixture from passing through the anchor aperture, and the at least one protrusion of the anchor lock being received in the at least one recessed portion of the anchor aperture; and the anchor being selectively secured to the anchor fixture by inserting the anchor lock through the anchor aperture and moving the anchor lock relative to the anchor fixture to place the anchor lock in the locked position, the anchor lock impeding movement within the anchor fixture of the anchor.

In some embodiments, the anchor comprises: an anchor stem, and an anchor lock connected to a first end of the anchor stem; and a lever connected to a second end of the anchor stem, the lever being rotatable to cause the anchor lock to rotate between the unlocked position and the locked position.

In some embodiments, the system further includes an anchor base configured to be connected to the other one of the accessory and the item; the anchor base defines a base aperture therein; the anchor is rotationally connected to the anchor base, a portion of the anchor extending through the base aperture; and the anchor base is disposed between the lever and the anchor lock.

In some embodiments, the system further includes an anchor base configured to be connected to the other one of the accessory and the item; the anchor base defines a base aperture therein; and the lever includes a handle portion having a passage defined therethrough, and a lever insert selectively disposed at least partially in the passage; the second end of the anchor stem is shaped to engage with an end portion of the lever insert; and the anchor being connected through the base aperture by: inserting the anchor stem through the base aperture and into one side of the passage of the handle portion, and inserting the lever insert into an other side of the passage.

In some embodiments, the lever insert comprises clips for maintaining connection of the lever insert, the handle portion, and the anchor stem.

In some embodiments, the anchor further comprises an indicator washer disposed between the lever and the anchor lock; and the indicator washer includes: a washer body, and a washer stop extending from the washer body, the washer stop extending parallel to the anchor stem.

In some embodiments, when the anchor is separated and spaced from the anchor fixture: the lever, the anchor lock, and the indicator washer are rotatable relative to a base aperture defined by one of an anchor base and the one of the accessory and the item; and when the anchor lock is inserted into the anchor aperture: the washer stop is received in the anchor aperture, rotational movement of the indicator washer being impeded by the anchor fixture, the washer stop abutting edges of the anchor aperture when the anchor is rotated, and the lever and the anchor lock are rotatable relative to the indicator washer, the base aperture, and the anchor fixture.

In some embodiments, the indicator washer includes at least one visual indicator, the at least one visual indicator providing a visual indication of a locking status of the anchor to a user.

In some embodiments, the anchor further comprises a lock washer disposed between the base aperture and the anchor lock; and the indicator washer is disposed between the lever and the base aperture.

In some embodiments, the lock washer has defined therein: a channel, and a central aperture; the anchor stem extends through the central aperture; the washer stop extends through the channel, the channel being sized and shaped to permit movement of the washer stop relative to the lock washer; and when the anchor lock is inserted into the anchor aperture: the lock washer rotates relative to the indicator washer.

In some embodiments, the lever has a plurality of slots defined therein; and the lock washer comprises a plurality of teeth disposed on one surface thereof, the plurality of teeth being shaped and arranged to engage with the plurality of slots of the

In some embodiments, the at least one recessed portion of the anchor fixture is at least one arc-shaped recess formed by the anchor fixture.

In some embodiments, the at least one recessed portion of the anchor fixture includes two oppositely disposed recessed portions; the at least one protrusion of the anchor lock includes two oppositely disposed protrusions formed by the anchor lock; and each protrusion is received in a corresponding one of the recessed portions when the anchor lock is in the locked position.

In some embodiments, the anchor lock comprises two cams extending from opposite sides of the anchor stem; and each of the two protrusions is formed from a protruding surface extending from the anchor stem to a corresponding one of the two cams.

In some embodiments, the anchor aperture is a hexagonal aperture; the hexagonal aperture is defined by two end side portions and four longitudinal side portions; each of the two end side portions are shorter than each of the four longitudinal side portions; a line extending between the two end side portions defining a major axis of the anchor aperture; a line extending through a first junction of a first pair of the longitudinal side portions to a second junction of a second pair of the longitudinal side portions defining a minor axis of the anchor aperture; and the major axis is larger than the minor axis.

In some embodiments, the anchor lock impedes movement along the major axis of the anchor aperture of the anchor within the anchor fixture.

In some embodiments, the anchor lock impedes movement along the major axis and the minor axis of the anchor aperture of the anchor within the anchor fixture.

In some embodiments, the anchor lock impedes lateral movement of the anchor within the anchor fixture.

In some embodiments, the anchor lock impedes movement of the anchor: parallel to the anchor aperture; and orthogonal to the anchor aperture.

According to another aspect of the present technology, there is provided an anchor for a system for connecting an accessory to an item, the anchor being configured to be connected to one of the accessory and the item, the anchor comprising: an anchor stem; an anchor lock connected to a first end of the anchor stem, the anchor lock being configured to be inserted through an anchor aperture of an anchor fixture, the anchor lock having at least one protrusion extending therefrom, the anchor lock being movable relative to the anchor fixture between an unlocked position and a locked position, in the unlocked position, the anchor lock being free to pass through the anchor aperture, and in the locked position: the anchor lock being prevented by the anchor fixture from passing through the anchor aperture, and the at least one protrusion of the anchor lock being received in a recessed portion of the anchor aperture; and the anchor being selectively secured to the anchor fixture by inserting the anchor lock through the anchor aperture and moving the anchor lock the anchor lock impeding movement within the anchor fixture of the anchor.

In some embodiments, the anchor further includes a lever connected to a second end of the anchor stem, the lever being rotatable to cause the anchor lock to rotate between the unlocked position and the locked position.

In some embodiments, the at least one protrusion received in the at least one recessed portion impedes movement of the anchor within the anchor fixture.

In some embodiments, the anchor further includes an anchor base configured to be connected to the other one of the accessory and the item; the anchor base defines a base aperture therein; the anchor is rotationally connected to the anchor base, a portion of the anchor extending through the base aperture; and the anchor base is disposed between the lever and the anchor lock.

In some embodiments, the lever includes: a handle portion having a passage defined therethrough, and a lever insert selectively disposed at least partially in the passage; the second end of the anchor stem is shaped to engage with an end portion of the lever insert; and the anchor being connected through the base aperture by: inserting the anchor stem through the base aperture and into one side of the passage of the handle portion, and inserting the lever insert into an other side of the passage.

In some embodiments, the lever insert comprises clips for maintaining connection of the lever insert, the handle portion, and the anchor stem.

In some embodiments, the anchor further comprises an indicator washer disposed between the lever and the anchor lock; and the indicator washer includes: a washer body, and a washer stop extending from the washer body, the washer stop extending parallel to the anchor stem.

In some embodiments, when the anchor is separated and spaced from the anchor fixture: the lever, the anchor lock, and the indicator washer are rotatable relative to a base aperture defined by one of an anchor base and the one of the accessory and the item; and when the anchor lock is inserted into the anchor aperture: the washer stop is received in the anchor aperture, rotational movement of the indicator washer being impeded by the anchor fixture, the washer stop abutting edges of the anchor aperture when the anchor is rotated, and the lever and the anchor lock are rotatable relative to the indicator washer, the base aperture, and the anchor fixture.

In some embodiments, the indicator washer includes at least one visual indicator, the at least one visual indicator providing a visual indication of a locking status of the anchor to a user.

In some embodiments, the anchor further comprises a lock washer disposed between the base aperture and the anchor lock; and the indicator washer is disposed between the lever and the base aperture.

In some embodiments, the lock washer has defined therein: a channel, and a central aperture; the anchor stem extends through the central aperture; the washer stop extends through the channel, the channel being sized and shaped to permit movement of the washer stop relative to the lock washer; and when the anchor lock is inserted into the anchor aperture: the lock washer rotates relative to the indicator washer.

In some embodiments, the lever has a plurality of slots defined therein; and the lock washer comprises a plurality of teeth disposed on one surface thereof, the plurality of teeth being shaped and arranged to engage with the plurality of slots of the

In some embodiments, the at least one protrusion of the anchor lock includes two oppositely disposed protrusions formed by the anchor lock; and each protrusion is received in a corresponding one of a plurality of recessed portions of the anchor aperture when the anchor lock is in the locked position.

In some embodiments, the anchor lock comprises two cams extending from opposite sides of the anchor stem; and each of the two protrusions is formed from a protruding surface extending from the anchor stem to a corresponding one of the two cams.

According to another aspect of the present technology, there is provided a system for connecting an accessory to an item, the system comprising: a first anchor fixture configured to be connected to the item, the first anchor fixture defining a first anchor chamber and a first anchor aperture opening into the first anchor chamber; a second anchor fixture configured to be connected to the item, the second anchor fixture defining a second anchor chamber and a second anchor aperture opening into the second anchor chamber; and an attachment base comprising: a base body configured to be connected to the accessory; a snap joint attached to the base body at a first end portion of the base body, the snap joint being shaped and adapted for selectively inserting into the first anchor aperture; and an anchor lock attached to the base body at a second end portion of the base body opposite the first end portion, the anchor lock being selectively inserted into the second anchor aperture, the anchor lock, when inserted into the second anchor aperture, being rotatable relative to the second anchor fixture between an unlocked position and a locked position, in the locked position: the anchor lock being disposed in the second anchor chamber and being prevented by the second anchor fixture from passing through the second anchor aperture, and the snap joint being generally aligned with the first anchor aperture of the first anchor fixture to be selectively inserted into the first anchor aperture, in the unlocked position: the anchor lock being free to pass through the second anchor aperture, and the snap joint being misaligned with the first anchor fixture, an entirety of the attachment base being rotated with the anchor lock to move the anchor lock between the unlocked position and the locked position.

In some embodiments, the snap joint is a U-shaped snap fit joint, the U-shaped snap fit joint including: a U-shaped body shaped and arranged to be inserted into the anchor aperture, a first end of the U-shaped body being connected to the base body; the U-shaped body having a ridge on an exterior side of the U-shaped body; and a tab connected to and extending from a second end of the U-shaped body.

In some embodiments, when the U-shaped snap fit joint is inserted into the first anchor aperture, a top edge of the ridge abuts an edge of the first anchor aperture to selectively maintain the U-shaped snap fit joint in the first anchor fixture; and the U-shaped snap fit joint is selectively removed from the first anchor aperture by using the tab to bend the second end of the U-shaped body toward the first end of the U-shaped body, thereby permitting the ridge to pass the edge of the first anchor aperture.

In some embodiments, the base body is at least partially flexible, the base body flexing to permit the snap joint to be selectively inserted into and removed from the first anchor aperture when the anchor lock is in the locked position.

In some embodiments, when in the unlocked position, a long axis of the attachment base is positioned perpendicular to a line extending through centers of the first and second anchor apertures of the first and second anchor fixtures; and when in the locked position, the long axis of the attachment base is positioned parallel to the line extending through the centers of the first and second anchor apertures of the first and second anchor fixtures.

In some embodiments, the base body and the snap joint are integrally formed.

In some embodiments, the base body, the anchor lock, and the snap joint are integrally formed.

In some embodiments, the attachment base further comprises a stem extending from the base body, the anchor lock extending from the stem.

In some embodiments, the anchor lock comprises two cams extending from opposite sides of the stem.

According to another aspect of the present technology, there is provided an attachment base for connecting an accessory to an item, an attachment base comprising: a base body configured to be connected to the accessory; a snap joint attached to the base body at a first end portion of the base body, the snap joint being shaped and adapted for inserting into a first anchor aperture of a first anchor fixture connected to the item; and an anchor lock attached to the base body at a second end portion of the base body opposite the first end portion, the anchor lock being adapted for inserting into a second anchor aperture of a second anchor fixture connected to the item, the anchor lock being rotatable relative to the second anchor fixture between an unlocked position and a locked position, in the locked position: the anchor lock being disposed in the second anchor chamber and being prevented by the second anchor fixture from passing through the second anchor aperture, and the snap joint being aligned with the first anchor aperture of the first anchor fixture to be selectively inserted into the first anchor aperture, in the unlocked position: the anchor lock being free to pass through the second anchor aperture, and the snap joint being misaligned with the first anchor fixture, an entirety of the attachment base being rotated with the anchor lock to move the anchor lock between the unlocked position and the locked position.

In some embodiments, the attachment base further includes a stem extending from the base body, the anchor lock extending from the stem.

In some embodiments, the anchor lock comprises two cams extending from opposite sides of the stem.

In some embodiments, the snap joint is a U-shaped snap fit joint, the U-shaped snap fit joint including: a U-shaped body shaped and arranged to be inserted into the anchor aperture, a first end of the U-shaped body being connected to the base body; the U-shapes body having a ridge on an exterior side of the U-shaped body; and a tab connected to and extending from a second end of the U-shaped body.

In some embodiments, when the U-shaped snap fit joint is inserted into the first anchor aperture, a top edge of the ridge abuts an edge of the anchor aperture to selectively maintain the U-shaped snap fit joint in the first anchor fixture; and the U-shaped snap fit joint is selectively removed from the first anchor aperture by using the tab to bend the second end of the U-shaped body toward the first end of the U-shaped body, thereby permitting the ridge to pass the edge of the first anchor aperture.

In some embodiments, the base body is at least partially flexible, the base body flexing to permit the snap joint to be selectively inserted into and removed from the first anchor aperture when the anchor lock is in the locked position.

In some embodiments, the base body and the snap joint are integrally formed.

In some embodiments, the base body, the anchor lock, and the snap joint are integrally formed.

According to another aspect of the present technology, there is provided a method for connecting an accessory to an item, the method comprising: inserting an anchor lock of an attachment base connected to the accessory into a first anchor aperture of a first anchor fixture connected to the item; rotating the attachment base to rotate the anchor lock into a locked position; and inserting a snap joint of the attachment base into a second anchor aperture of a second anchor fixture connected to the item.

According to another aspect of the present technology, there is provided a system for connecting an accessory to an item. The system comprises: an anchor fixture configured to be connected to one of the accessory and the item, the anchor fixture defining an anchor chamber and an anchor aperture opening into the anchor chamber; and an anchor configured to be connected to an other one of the accessory and the item, the anchor comprising an anchor lock, the anchor lock being configured to be inserted through the anchor aperture and into the anchor chamber of the anchor fixture, the anchor lock being rotatable relative to the anchor fixture between an unlocked position and a locked position, in the unlocked position, the anchor lock being free to pass through the anchor aperture, in the locked position, the anchor lock being disposed in the anchor chamber and being prevented by the anchor fixture from passing through the anchor aperture, an entirety of the anchor being rotated to move the anchor lock between the unlocked position and the locked position, the anchor being selectively secured to the anchor fixture by inserting the anchor lock into the anchor chamber and moving the anchor lock relative to the anchor fixture to place the anchor lock in the locked position.

In some embodiments, the anchor comprises an anchor base having a lower surface, the anchor lock being spaced from the lower surface.

In some embodiments, the anchor further comprises a stem extending from the anchor base, the anchor lock extending from the stem.

In some embodiments, the anchor lock comprises two cams extending from opposite sides of the stem.

In some embodiments, the anchor comprises an accessory mount for connection to the accessory.

In some embodiments, the one of the accessory and the item is the item.

In some embodiments, the anchor fixture comprises an edge portion configured to be sewn to the item.

In some embodiments, the anchor fixture comprises a first electrical element; the anchor comprises a second electrical element; and the first and second electrical elements are configured to be in contact with each other to establish electrical communication therebetween.

In some embodiments, the anchor further comprises a latching feature for selectively engaging the anchor fixture to prevent rotation of the anchor lock from the locked position to the unlocked position.

In some embodiments, the latching feature comprises a latching protrusion that is selectively insertable within an aperture defined by the anchor fixture, the latching protrusion preventing rotation of the anchor lock from the locked position to the unlocked position in response to the latching protrusion being inserted into the aperture.

In some embodiments, the aperture is the anchor aperture.

In some embodiments, the anchor further comprises a handle for handling by a user, the handle being operatively connected to the latching feature such that the latching feature is actuated by operation of the handle.

In some embodiments, the anchor chamber is defined on a concave side of the anchor fixture.

In some embodiments, the anchor fixture comprises at least one interlocking member disposed in the anchor chamber, the at least one interlocking member being configured to engage the anchor lock in the locked position to retain the anchor lock.

According to another aspect of the present technology, there is provided a garment accessory system. The garment accessory system comprises: a garment comprising a textile body; an accessory comprising an accessory body; an anchor fixture connected to one of the textile body and the accessory body, the anchor fixture at least partly defining an anchor chamber, the anchor fixture defining an anchor aperture opening into the anchor chamber; an anchor connected to an other one of the textile body and the accessory body, the anchor comprising an anchor lock configured to be inserted through the anchor aperture and into the anchor chamber, the anchor lock being rotatable relative to the anchor fixture between an unlocked position and a locked position, in the unlocked position, the anchor lock being free to pass through the anchor aperture, in the locked position, the anchor lock being disposed in the anchor chamber and being prevented by the anchor fixture from passing through the anchor aperture, the anchor being selectively secured to the anchor fixture by inserting the anchor lock into the anchor chamber and moving the anchor lock relative to the anchor fixture to place the anchor lock in the locked position.

In some embodiments, the one of the textile body and the accessory body is the textile body.

In some embodiments, an entirety of the anchor is rotated to move the anchor lock between the unlocked position and the locked position.

In some embodiments, the anchor fixture is sewn to the textile body.

In some embodiments, a stitching connecting the anchor fixture to the textile body surrounds the anchor chamber.

In some embodiments, the anchor fixture comprises a first electrical element; the anchor comprises a second electrical element; and the first and second electrical elements are configured to be in contact with each other to establish electrical communication therebetween.

In some embodiments, the garment further comprises a power connector configured to connect the garment to a power source, the power connector being in electrical communication with the first electrical element of the anchor fixture.

In some embodiments, the power connector is configured to be connected to a power source of a vehicle.

In some embodiments, the anchor fixture comprises a wall portion defining the anchor aperture; the first electrical element comprises a first contact portion; the second electrical element comprises a second contact portion; and in the locked position of the anchor lock, the first and second contact portions are disposed within the anchor chamber between the textile body and the wall portion of the anchor fixture.

In some embodiments, the anchor further comprises a latching feature for selectively engaging the anchor fixture to prevent rotation of the anchor lock from the locked position to the unlocked position.

In some embodiments, the latching feature comprises a latching protrusion that is selectively insertable within an aperture defined by the anchor fixture, the latching protrusion preventing rotation of the anchor lock from the locked position to the unlocked position in response to the latching protrusion being inserted into the aperture.

In some embodiments, the aperture is the anchor aperture.

In some embodiments, the anchor further comprises a handle for handling by a user, the handle being operatively connected to the latching feature such that the latching feature is actuated by operation of the handle.

In some embodiments, the garment is one of a jacket, a pair of pants and

a personal floatation device.

In some embodiments, the accessory is one of a walkie-talkie and an electronic navigation device.

In some embodiments, the anchor fixture comprises at least one interlocking member disposed in the anchor chamber. the at least one interlocking member being configured to engage the anchor lock in the locked position to retain the anchor lock.

In some embodiments, an entirety of the accessory is rotated to move the anchor lock between the unlocked position and the locked position.

According to another aspect of the present technology, there is provided a system for connecting an accessory to an item. The system comprises: an anchor fixture comprising: a fixture body configured to be connected to one of the accessory and the item, the fixture body defining an anchor aperture; and a first electrical element connected to the fixture body; and an anchor comprising: an anchor base configured to be connected to an other one of the accessory and the item; an anchor lock connected to the anchor base, the anchor lock being configured to be inserted through the anchor aperture of the anchor fixture, the anchor lock being movable relative to the anchor fixture between an unlocked position and a locked position, in the unlocked position, the anchor lock being free to pass through the anchor aperture, in the locked position, the anchor lock being prevented by the anchor fixture from passing through the anchor aperture, the anchor being selectively secured to the anchor fixture by inserting the anchor lock through the anchor aperture and moving the anchor lock relative to the anchor fixture to place the anchor lock in the locked position; and a second electrical element configured to contact the first electrical element to electrically connect the anchor fixture to the anchor, a given one of the first electrical element and the second electrical element that is configured to be connected to the accessory being configured to be electrically connected to the accessory.

In some embodiments, the second electrical element is disposed on one of the anchor base and the anchor lock.

In some embodiments, the anchor further comprises an anchor power connector configured to electrically connect the anchor to one of the accessory and a power source, the anchor power connector being electrically connected to the second electrical element to conduct electricity between the second electrical element and the one of the accessory and the power source.

In some embodiments, the anchor fixture comprises a fixture power connector configured to electrically connect the anchor fixture to an other one of the accessory and the power source, the fixture power connector being electrically connected to the first electrical element to conduct electricity between the first electrical element and the other one of the accessory and the power source.

In some embodiments, the anchor fixture defines an anchor chamber, the anchor aperture opening into the anchor chamber; the anchor lock is configured to be inserted through the anchor aperture into the anchor chamber; and in the locked position, the anchor lock is disposed in the anchor chamber.

In some embodiments, one of the first electrical element and the second electrical element comprises at least one spring loaded pin configured to retract in response to the anchor lock being in the anchor chamber and placed in the locked position.

In some embodiments, the one of the first electrical element and the second electrical element is the second electrical element.

In some embodiments, the first electrical element is disposed within the anchor chamber.

In some embodiments, the anchor fixture further comprises a backing member defining the anchor chamber together with the fixture body, the backing member comprising the first electrical element.

In some embodiments, the first electrical element is disposed on a top surface of the anchor fixture.

In some embodiments, the anchor further comprises a lever operatively connected to the anchor lock, the lever being rotatable to cause the anchor lock to rotate between the unlocked position and the locked position.

In some embodiments, the anchor base has a lower surface, the anchor lock being spaced from the lower surface.

In some embodiments, the anchor further comprises a stem extending from the anchor base, the anchor lock extending from the stem.

In some embodiments, the anchor lock comprises two cams extending from opposite sides of the stem.

In some embodiments, an entirety of the anchor is rotated to move the anchor lock between the unlocked position and the locked position.

In some embodiments, the fixture body is configured to be connected to the item; and the anchor base is configured to be connected to the accessory.

According to another aspect of the present technology there is provided an anchor for connecting an accessory to an item. The anchor comprises: an anchor base configured to be connected to the accessory; an anchor lock connected to the anchor base, the anchor lock being configured to be inserted through into an anchor chamber of an anchor fixture connected to the item, the anchor lock being movable relative to the anchor fixture between an unlocked position and a locked position, in the unlocked position, the anchor lock being free to be removed from the anchor chamber through an anchor aperture of the anchor fixture, in the locked position, the anchor lock being disposed in the anchor chamber and being prevented by the anchor fixture from being removed from the anchor chamber through the anchor aperture, the anchor being configured to be selectively secured to the anchor fixture by inserting the anchor lock into the anchor chamber and moving the anchor lock relative to the anchor fixture to place the anchor lock in the locked position; and an anchor electrical element configured to contact a corresponding fixture electrical element of the anchor fixture to electrically connect the anchor to the anchor fixture, the anchor electrical element being configured to be electrically connected to the accessory.

In some embodiments, the anchor further comprises an anchor power connector configured to electrically connect the anchor to the accessory, the anchor power connector being electrically connected to the anchor electrical element to conduct electricity to the accessory.

In some embodiments, the anchor electrical element comprises at least one spring loaded pin configured to retract in response to the anchor lock being in the anchor chamber and placed in the locked position.

In some embodiments, the anchor electrical element is disposed on one of the anchor base and the anchor lock.

In some embodiments, the anchor base has a lower surface, the anchor lock being spaced from the lower surface.

In some embodiments, the anchor further comprises a stem extending from the anchor base, the anchor lock extending from the stem.

In some embodiments, the anchor lock comprises two cams extending from opposite sides of the stem.

In some embodiments, an entirety of the anchor is rotated to move the anchor lock between the unlocked position and the locked position.

In some embodiments, the anchor further comprises a lever operatively connected to the anchor lock, the lever being rotatable to cause the anchor lock to rotate between the unlocked position and the locked position.

For purposes of the present application, the accessory could be implemented as a variety of objects. The accessory could be one or more of, but is not limited to, storage containers, bags, pouches, nets, speakers, lights or illumination devices, communication devices (for example, walkie-talkies), toolkits, fishing pouch/tools, hunting tools, winch remotes, quick detaches for vehicle body panels, helmets, helmet accessories, cameras, phones, food containers, and water bottles.

For purposes of the present application, terms related to spatial orientation when referring to a vehicle and components in relation to the vehicle, such as “forwardly”, “rearwardly”, “left”, “right”, “above” and “below”, are as they would be understood by a driver of the vehicle, with the vehicle, in a straight ahead orientation (i.e. not steered left or right), and in an upright position. When referring to a component alone, terms related to spatial orientation should be taken with respect to the component itself. The explanations provided above regarding the above terms take precedence over explanations of these terms that may be found in any one of the documents referenced herein.

Embodiments of the present invention each have at least one of the above-mentioned object and/or aspects, but do not necessarily have all of them. It should be understood that some aspects of the present invention that have resulted from attempting to attain the above-mentioned object may not satisfy this object and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a right side elevation view of a snowmobile;

FIG. 2 is a perspective view, taken from a top, rear, right side, of a system for connecting an accessory to the snowmobile of FIG. 1;

FIG. 3 is a perspective view, taken from a top, rear, left side, of an anchor fixture and an anchor of the system of FIG. 2 shown in a disassembled configuration;

FIG. 4 is a perspective view, taken from a top, front, left side, of the anchor fixture and the anchor of FIG. 3;

FIG. 5 is a perspective view, taken from a top, rear, left side, of the anchor fixture and the anchor of FIG. 3, shown with the anchor secured to the anchor fixture;

FIG. 6 is a perspective view, taken from a top, front, left side, of the anchor fixture and the anchor of FIG. 5;

FIG. 7 is a perspective view, taken from a top, front, right side, of the anchor fixture and the anchor of FIG. 5;

FIG. 8 is a bottom plan view of the anchor fixture and the anchor of FIG. 5;

FIG. 9 is a bottom plan view of the anchor fixture and the anchor of FIG. 3, shown with an anchor lock of the anchor in an unlocked position;

FIG. 10 is a front elevation view of a garment having a plurality of systems for connecting accessories to a garment body of the garment;

FIG. 11 is a top perspective view of one of the systems of FIG. 10;

FIG. 12 is a perspective view, taken from a top, front, right side, of the system of FIG. 11, shown with an anchor and an anchor fixture thereof in a disassembled configuration;

FIG. 13 is a perspective view, taken from a bottom, front, right side, of the system of FIG. 12;

FIG. 14 is a perspective view, taken from a top, front, left side, of the system of FIG. 11, shown with the anchor and the anchor fixture thereof assembled and with an anchor lock of the anchor being in an unlocked position;

FIG. 15 is a front elevation view of the system of FIG. 11, shown with the anchor lock being in a locked position and a latching feature of the anchor being in an unlatched position;

FIG. 16 is a perspective view, taken from a top, front, left side, of the system of FIG. 11, shown with the anchor lock being in a locked position and the latching feature being in a latched position;

FIG. 17 is a bottom plan view of the system of FIG. 16;

FIG. 18 is a top plan view of the anchor fixture of the system of FIG. 11;

FIG. 19A is a top plan view of an alternative embodiment of the anchor fixture of the system of FIG. 11;

FIG. 19B is a top plan view of another alternative embodiment of the anchor fixture of the system of FIG. 11;

FIG. 20 is a bottom perspective view of another embodiment of the anchor of the system of FIG. 11, shown connected to an accessory and with the latching feature thereof in the latched position;

FIG. 21 is a bottom perspective view of the anchor and the accessory of FIG. 20, shown with the latching feature thereof in the unlatched position;

FIG. 22 is a perspective view of a cross-section of the anchor and accessory of FIG. 20 and a corresponding anchor fixture connected to a textile body of the garment;

FIG. 23 is a perspective view, taken from a top, front, left side, of another one of the systems of FIG. 10 including an anchor and an anchor fixture connected to each other;

FIG. 24 is a top plan view of the system of FIG. 23;

FIG. 25 is a perspective view of the anchor fixture and the anchor of FIG. 23, showing a top side of the anchor fixture and a bottom side of the anchor;

FIG. 26 is a perspective view of a cross-section taken along line 26-26 in FIG. 24;

FIG. 27 is a perspective view of a cross-section taken along line 27-27 in FIG. 24;

FIG. 28 is a plan view of the anchor fixture and the anchor of FIG. 23 with a backing member of the anchor fixture separated therefrom, a bottom side of a fixture body and the anchor and a top side of a backing member being shown;

FIG. 29 is a front elevation view of a garment having a plurality of systems for connecting accessories to a garment body of the garment, whereby the garment is connected to an external power source;

FIG. 30 is a perspective view taken from a front, right side of another system for connecting an accessory to an item according to the present technology, shown with an attachment base thereof in a partially connected configuration;

FIG. 31 is a top plan view of the system of FIG. 30, shown in the locked position with an accessory shown schematically;

FIG. 32 is a front elevation view of the system of FIG. 30, shown in the locked position with an accessory shown schematically;

FIG. 33 is a perspective view taken from a front, left side of the attachment base of the system of FIG. 30;

FIG. 34 is a top plan view of the attachment base of FIG. 33;

FIG. 35 is a bottom plan view of the attachment base of FIG. 33;

FIG. 36 is a bottom plan view of the attachment base of FIG. 33 and schematically illustrated anchor fixtures of the system of FIG. 30, illustrated in the unlocked position;

FIG. 37 is a bottom plan view of the attachment base and anchor fixtures of FIG. 36, illustrated in the locked position;

FIG. 38 is a side elevation view of another system for connecting an accessory to an item according to the present technology, shown in a disassembled configuration;

FIG. 39 is a front plan view of the system of FIG. 38 connecting speaker accessory to the snowmobile, shown in a disassembled configuration;

FIG. 40 is a perspective view taken from the front, bottom, side thereof of the speaker accessory of FIG. 39, illustrated with anchors of the system of FIG. 38;

FIG. 41 is a top plan view of the speaker accessory and anchors of FIG. 40;

FIG. 42 is a perspective view taken from the front, bottom, side thereof of another non-limiting example of an accessory to be connected to an item, illustrated with anchors of the system of FIG. 38;

FIG. 43 is an exploded, perspective view taken from the top, front side of the anchor of the system of FIG. 38;

FIG. 44 is an exploded, front elevation view of the anchor of FIG. 43;

FIG. 45 is a front elevation view of an anchor lock and stem of the anchor of FIG. 43;

FIG. 46A is a top plan view of an anchor fixture of the system of FIG. 38;

FIG. 46B is a bottom plan view of the anchor fixture of FIG. 46A;

FIG. 47A is a cross-sectional, perspective taken by from a top, right side of the anchor fixture of FIG. 46A, taken along a major axis of an anchor aperture of the anchor fixture;

FIG. 47B is a cross-sectional, perspective taken by from a bottom, left side of the anchor fixture of FIG. 46A, taken along the major axis of the anchor aperture;

FIG. 48 is a bottom plan view of the system of FIG. 38, shown in the unlocked position;

FIG. 49 is a bottom plan view of the system of FIG. 38, shown in the unlocked position;

FIG. 50 is a top plan view of the system of FIG. 38, shown in the locked position;

FIG. 51 is a cross-sectional view of the system of FIG. 38, taken along line 51-51 of FIG. 50; and

FIGS. 52 to 54 are top plan views of the system of FIG. 38, shown in the unlocked position with a variety of anchor orientations.

### DETAILED DESCRIPTION

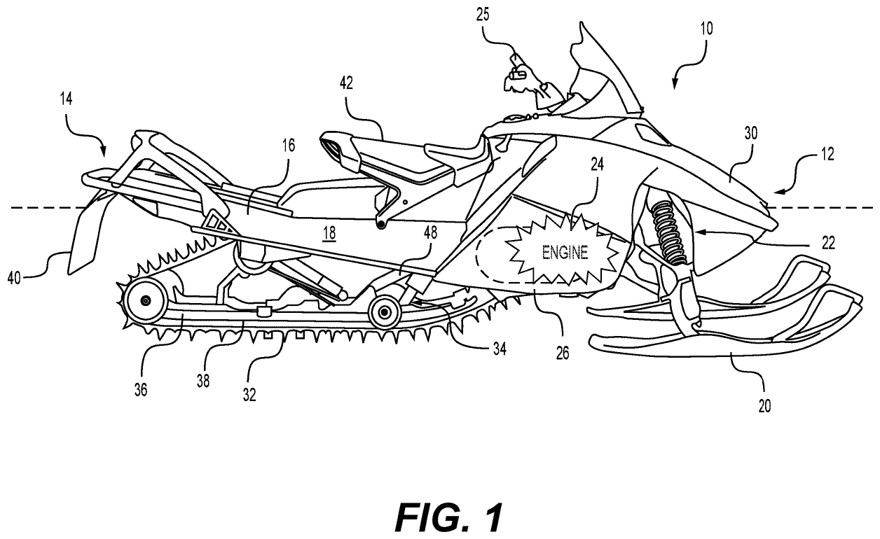

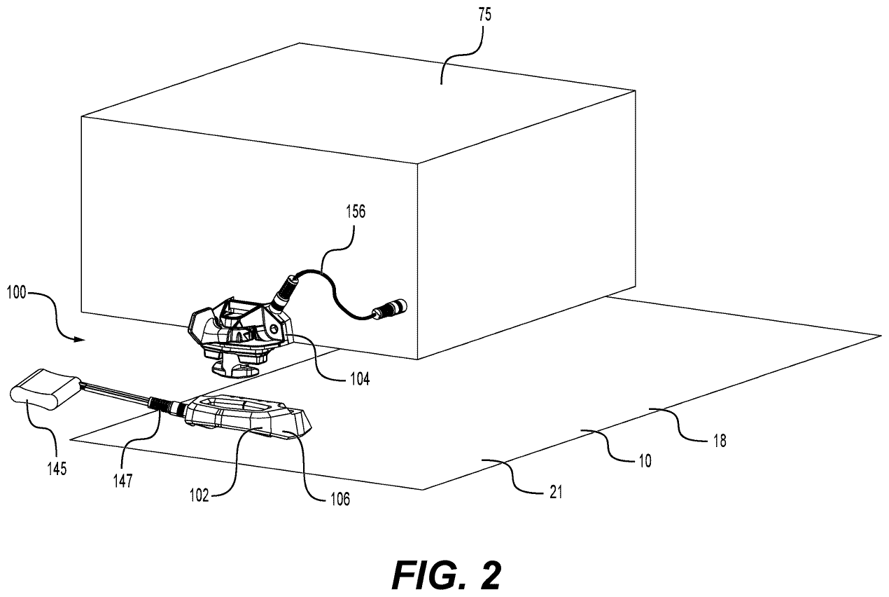

As will be described herein and as shown in FIG. 2, a system 100 is broadly provided for connecting an accessory 75 to an item such as a part of a vehicle 10 (FIG. 1). The vehicle 10 may be any suitable vehicle. In this embodiment, the vehicle 10 is a snowmobile. The snowmobile 10 will be broadly described with reference to FIG. 1. It should be understood that the snowmobile 10 could have a construction different than the one described.

The snowmobile 10 has a front end 12 and a rear end 14, which are defined with respect to a forward travel direction of the snowmobile 10. The snowmobile 10 has a frame 16 which includes a tunnel 18. Skis 20 and a steering assembly 22 are provided at the front end 12 of the snowmobile 10. The steering assembly 22 includes a handlebar 25 that is operable by a driver of the snowmobile 10 to steer the snowmobile 10. A motor 24 and a belt transmission system 26 (shown schematically) disposed near the front end 12 are enclosed by fairings 30 which protect the engine 24 and the belt transmission system 26. In this embodiment, the motor 24 is an internal combustion engine.

In the rear section of the snowmobile 10, an endless drive track 32 is disposed under the tunnel 18. The endless drive track 32 is operatively connected to the engine 24 through the belt transmission system 26. The endless drive track 32 is driven to run about a rear suspension assembly 34 for propulsion of the snowmobile 10. The rear suspension assembly 34 includes a slide frame assembly 36 which includes a pair of spaced apart slide rails 38 that engage the inner side of the ground-engaging portion of the endless drive track 32. A snowflap 40 is disposed at the rear end 14 of the snowmobile 10.

A driver seat 42 is installed in the rear section of the snowmobile 10. A rear portion of the driver seat 42 may include a storage compartment, or may be used to accept a passenger seat.

With reference to FIG. 2, the system 100 includes an anchor fixture 102 that is fixable to the snowmobile 10, and an anchor 104 that is mateable with the anchor fixture 102. The anchor fixture 102 can be connected to any suitable part of the snowmobile 10. For instance, in this embodiment, the anchor fixture 102 is connected to an upper surface 21 of the tunnel 18. The anchor fixture 102 may be connected to another part of the snowmobile 10 in other embodiments (e.g., an accessory-receiving rack or other structure).

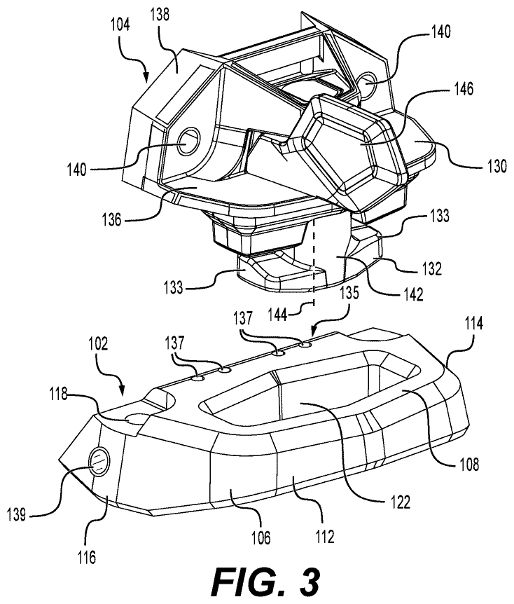

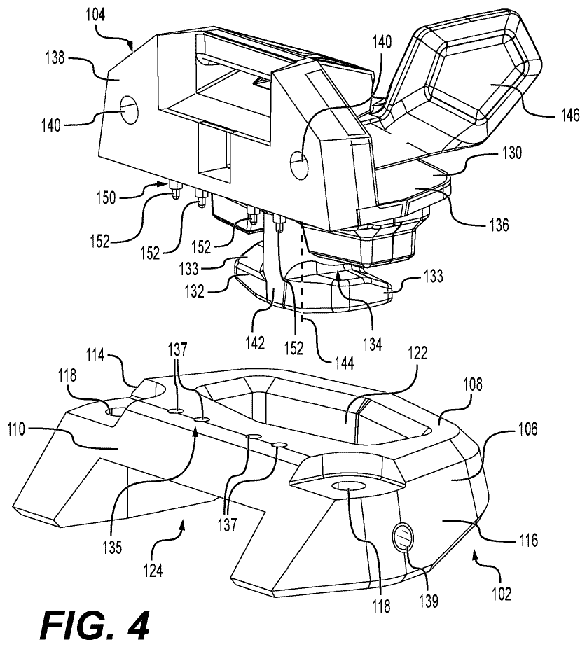

With reference to FIGS. 3 and 4, in this embodiment, the anchor fixture 102 has a fixture body 106 including a top wall portion 108, a front wall portion 110, a rear wall portion 112, a left side wall portion 114 and a right side wall portion 116. Each of the wall portions 108, 110, 112, 114, 116 has an interior surface and an exterior surface. As best shown in FIG. 4, the left and right side wall portions 114, 116 define openings 118 for receiving respective fasteners (e.g., bolts) to connect the anchor fixture 102 to the upper surface 21 of the tunnel 18. The interior surfaces of the wall portions 108, 110, 112, 114, 116 define an anchor chamber 120 that, as will be described in more detail below, is configured to receive therein a part of the anchor 104. The top wall portion 108 also defines an anchor aperture 122 that opens into the anchor chamber 120. As will be described below, part of the anchor 104 is inserted into the anchor chamber 120 through the anchor aperture 122 in order to secure the anchor 104 to the anchor fixture 102. In this embodiment, the front portion 110 also defines a fastener aperture 124 that opens into the anchor chamber 120. The fastener aperture 124 can be optionally used for inserting a tongue fastener (not shown) therein, thereby providing another way in which to secure an accessory to the anchor fixture 102. It is contemplated that the fastener aperture 124 could be omitted in other embodiments. An anchor fixture having this general structure is described in greater detail in U.S. Pat. No. 9,751,592, issued Sep. 5, 2017, the entirety of which is incorporated by reference herein. It is contemplated that the anchor fixture 102 may be configured differently in other embodiments. For instance, in some embodiments, the anchor fixture 102 could be a rack attached to the snowmobile 10 and defining the anchor aperture 122. In such embodiments, the anchor fixture 102 may not define an anchor chamber but rather simply a space below the top wall portion 108.

In this embodiment, the anchor fixture 102 also has a fixture electrical element 135 for establishing electrical communication between the anchor fixture 102 and the anchor 104. As can be seen, the fixture electrical element 135 is connected to the fixture body 106, namely being disposed on an outer surface of the top wall portion 108. Other positions of the fixture electrical element 135 are contemplated in other embodiments. In this embodiment, the fixture electrical element 135 includes a plurality of electrical contacts 137 made of an electrically conductive material (e.g., copper). The electrical contacts 137 are aligned with one another in a front-to-rear direction and laterally spaced from one another. Other arrangements of the electrical contacts 137 are also contemplated. As shown in FIG. 3, the anchor fixture 102 also has a fixture power connector 139 configured to electrically connect the anchor fixture 102 to a power source 145 (FIG. 2). In particular, the fixture power connector 139 is electrically connected to the electrical contacts 137 in order to conduct electricity between the electrical contacts 137 and the power source 145. In this embodiment, the fixture power connector 139 is a power receptacle configured for receiving a power plug that is electrically connected to the power source 145 via wiring 147. It is contemplated that, in other embodiments, the fixture power connector 139 could be hardwired instead of selectively receiving the power plug (i.e., the wiring 147 is fixedly attached to the anchor fixture 102 to electrically connect the anchor fixture 102 to the power source 145. In this embodiment, the power source 145 is a portable battery pack. It is contemplated that the power source 145 could be any other suitable power source in other embodiments, such as a battery of the snowmobile 10.

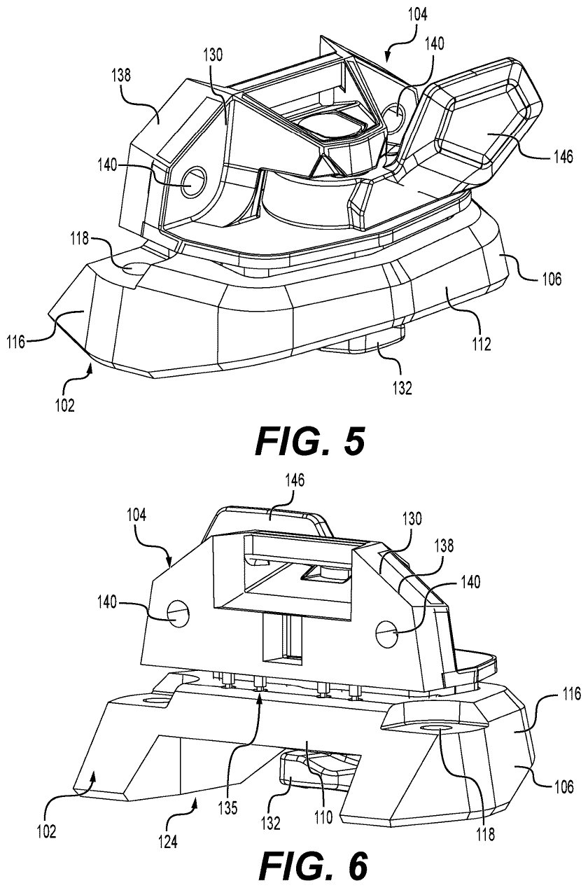

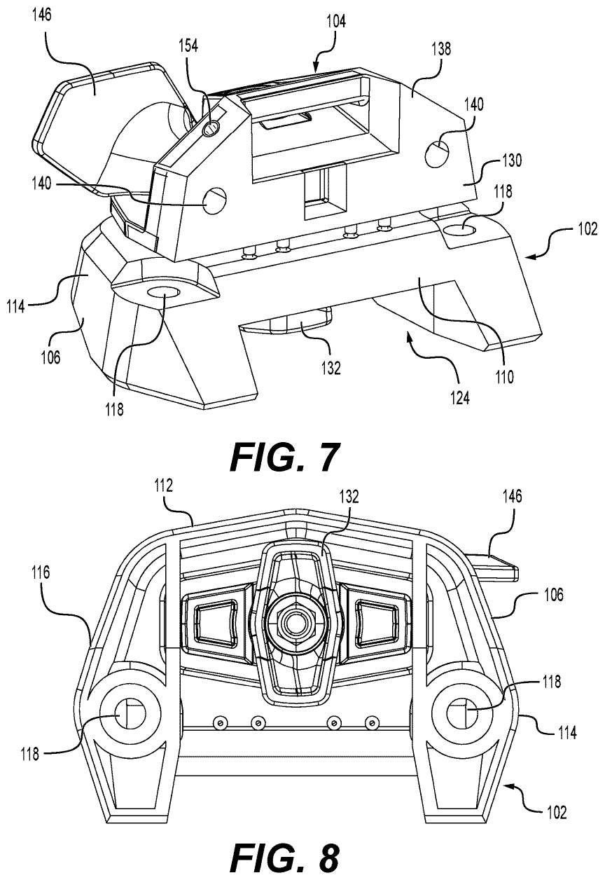

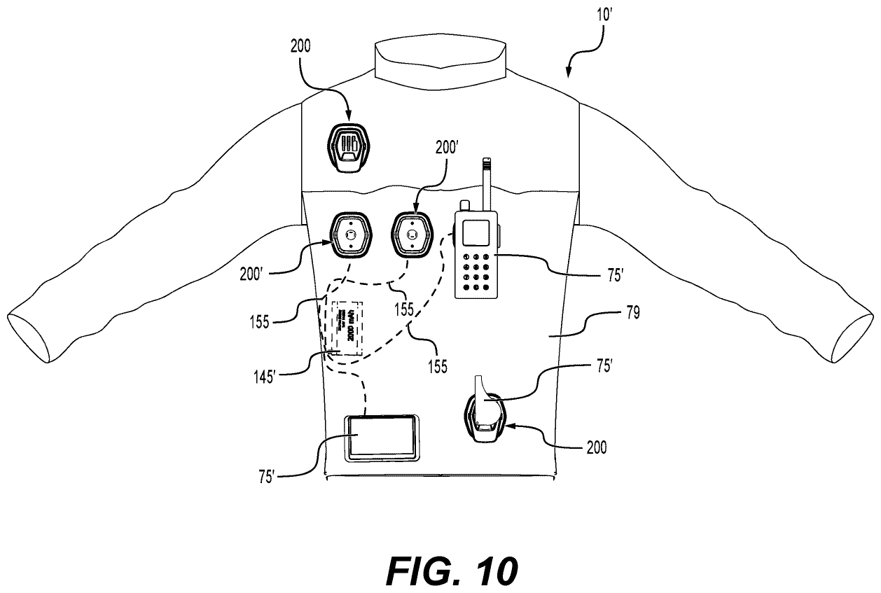

Turning to the anchor 104, with reference to FIGS. 3 and 4, in this embodiment, the anchor 104 has an anchor base 130 and an anchor lock 132 extending below the anchor base 130, spaced therefrom by a gap 134. The anchor base 130 has a horizontal portion 136 and an upright portion 138 generally perpendicular to the horizontal portion 136. The upright portion 138 is configured to be connected to a body of the accessory 75 (FIG. 2). Notably, in this embodiment, the upright portion 138 defines two fastener openings 140 for receiving respective fasteners (not shown) that engage the body of the accessory 75 such as to connect the anchor base 130 to the accessory 75. The anchor lock 132 is connected to the anchor base 130 via a stem 142 defining an axis 144. The anchor lock 132 includes two cams 133 extending from opposite sides of the stem 142 in opposite directions from each other. A lever 146 is connected to the stem 142, above the horizontal portion 136. The lever 146 allows a user to rotate the stem 142 about the axis 144, thereby rotating the anchor lock 132. In particular, the anchor lock 132 is rotatable about the axis 144 between locked and unlocked positions. In the unlocked position, illustrated in FIGS. 3 and 4, the anchor lock 132 extends generally parallel to the anchor base 130 such that the cams 133 are offset from one another in a direction of elongation of the anchor base 130. In the locked position, illustrated in FIGS. 5 to 8, the anchor lock 132 is rotated by 90° about the axis 144 relative to the unlocked position. A more complete description of the general structure of the anchor 104 can be found in U.S. Pat. No. 9,751,592.

In this embodiment, as best shown in FIG. 4, the anchor 104 also has an anchor electrical element 150 configured to contact the fixture electrical element 135. As can be seen, in this embodiment, the anchor electrical element 150 is connected to the anchor base 130, namely being disposed on a lower surface of the anchor base 130. Notably, this position of the anchor electrical element 150 ensures that it will come into contact with the fixture electrical element 135. It is contemplated that the anchor electrical element 150 may be positioned differently depending on the position of the fixture electrical element 135. In this embodiment, the anchor electrical element 150 includes a plurality of spring-loaded pins 152 made of an electrically conductive material (e.g., copper). In this example, four spring-loaded pins 152 are provided, each being positioned to contact a corresponding one of the electrical contacts 137 of the anchor fixture 102. In particular, the spring-loaded pins 152 are aligned to form a row with similar spacing as the electrical contacts 137 of the anchor fixture 102.

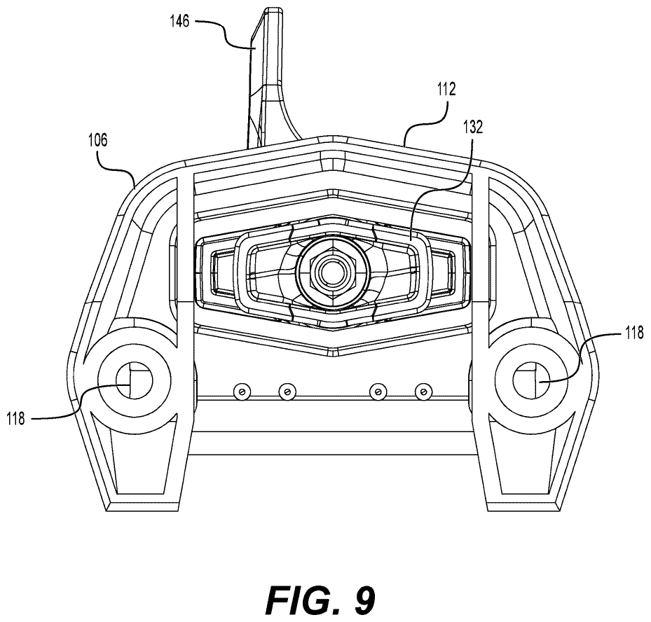

As shown in FIG. 7, the anchor 104 also has an anchor power connector 154 configured to electrically connect the anchor 104 to the accessory 75. In particular, the anchor power connector 154 is electrically connected to the spring-loaded pins 152 in order to conduct electricity between the spring-loaded pins 152 and the accessory 75.

In this embodiment, the anchor power connector 154 is a power receptacle configured for receiving a power plug that is electrically connected to the accessory 75 via wiring 156 (FIG. 2). It is contemplated that, in other embodiments, the anchor power connector 154 could be hardwired instead of selectively receiving the power plug (i.e., the wiring 56 is fixedly attached to the anchor 104 to electrically connect the anchor 104 to the accessory 75).

In order to secure the anchor 104 to the anchor fixture 102, the anchor lock 132 is placed in the unlocked position as shown in FIGS. 3 and 4 and the anchor lock 132 is then inserted through the anchor aperture 122 and into the anchor chamber 120 of the anchor fixture 102. Upon doing so, the anchor electrical element 150 comes into contact with the fixture electrical element 135. The anchor lock 132 is then rotated relative to the anchor fixture 102 to the locked position, shown in FIGS. 5 to 8, whereby the anchor lock 132 is disposed in the anchor chamber 120 and prevented by the anchor fixture 102 from passing through the anchor aperture 122. In the locked position, the pressure exerted by the cams 133 on the anchor fixture 102 cause the spring-loaded pins 152 of the anchor electrical element 150 to retract as they are forced against the electrical contacts 137 of the anchor fixture 102. Electrical communication between the fixture electrical elements 135 and the anchor electrical element 150 is thus established. As such, since the anchor electrical element 150 is electrically connected to the accessory 75 while the fixture electrical element 135 is electrically connected to the power source 145, the accessory 75 is electrically connected to the power source 145 via the anchor 104 and the anchor fixture 102.

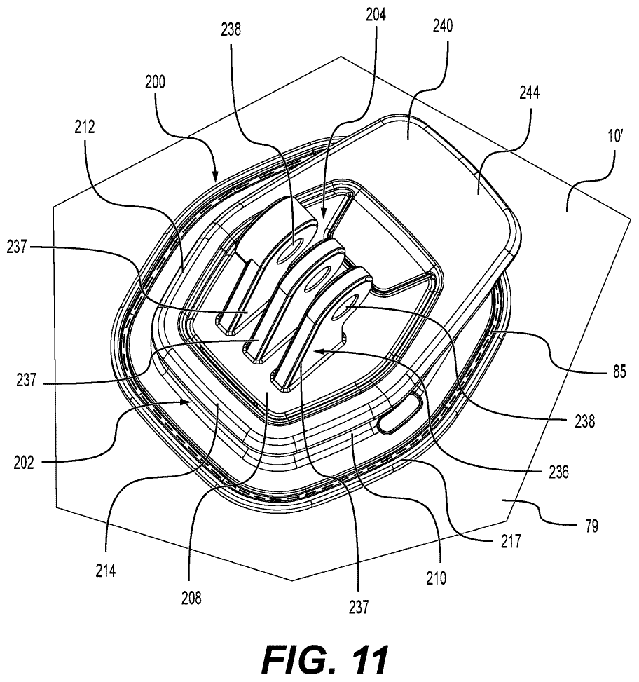

In order to disconnect the anchor 104 from the anchor fixture 102, the anchor lock 132 is placed in the unlocked position whereby, as best shown in FIG. 9, the anchor lock 132 is free to pass through the anchor aperture 122. Upon moving the anchor lock 132 to the unlocked position, the spring-loaded pins 152 are withdrawn as they cease being forced inward by the electrical contacts 137. The anchor 104 is then lifted to extract the anchor lock 132 from the anchor chamber 120 through the anchor aperture 122.

It is contemplated that, in other embodiments, the roles of the anchor 104 and the anchor fixture 102 may be reversed. Notably, in some embodiments, the anchor fixture 102 could be connected to the accessory 75 (rather than the snowmobile 10), and the anchor 104 could be connected to the snowmobile 10 (rather than the accessory 75). For instance, in such embodiments, the anchor fixture 102 and the anchor 104 may be electrically connected to the accessory 75 and the power source 145 respectively.

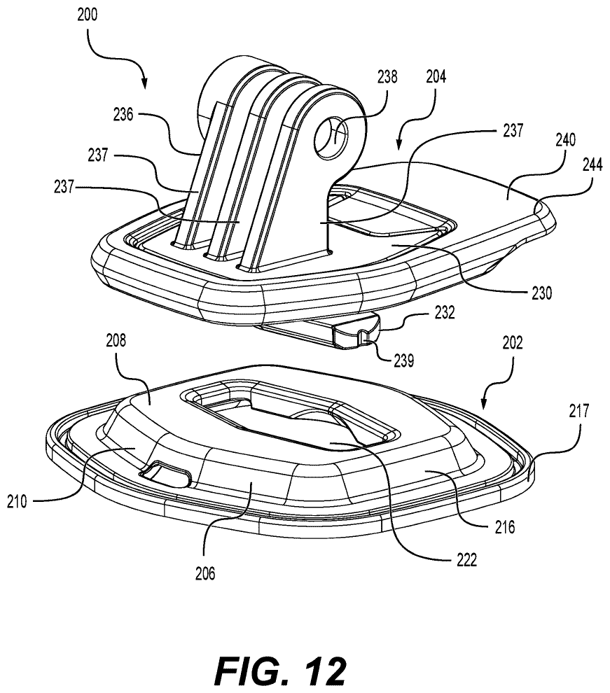

With reference now to FIG. 10, another embodiment of a system 200 for connecting an accessory 75′ to an item 10′ will be described herein. In this embodiment, the item 10′ is a soft item such as textile-based item. In particular, the item 10′ is a garment and specifically a jacket. However, the garment 10′ may be any other type of garment in other embodiments (e.g., a pair of pants, a personal floatation device, etc.). In other examples, the item 10′ may be another type of soft item (e.g., a duffle bag).

The system 200 includes an anchor fixture 202 that is fixable to the garment 10′, and an anchor 204 that is mateable with the anchor fixture 202. In this embodiment, the anchor fixture 202 is connected to a textile body 79 of the garment 10′ while the anchor 204 is connected (fixedly or removably) to the accessory 75′. The accessory 75′ may be any suitable accessory for fixing to the garment 10′. For example, as illustrated in FIG. 10, the accessory 75′ can be a communication device (e.g., a walkie-talkie), an electronic navigation device, or a whistle. Other types of accessories are also contemplated.

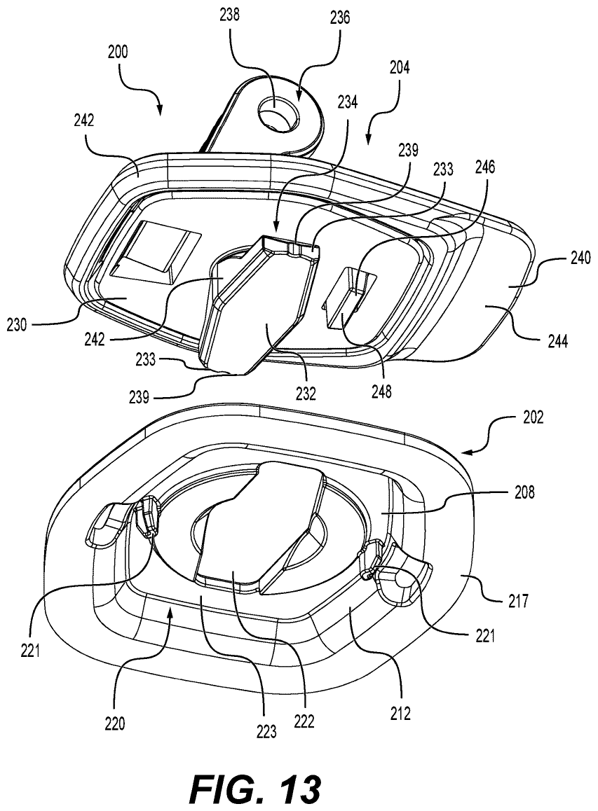

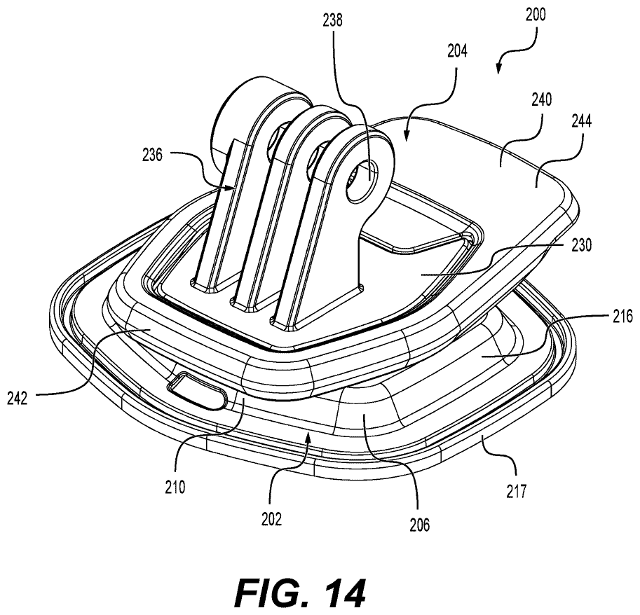

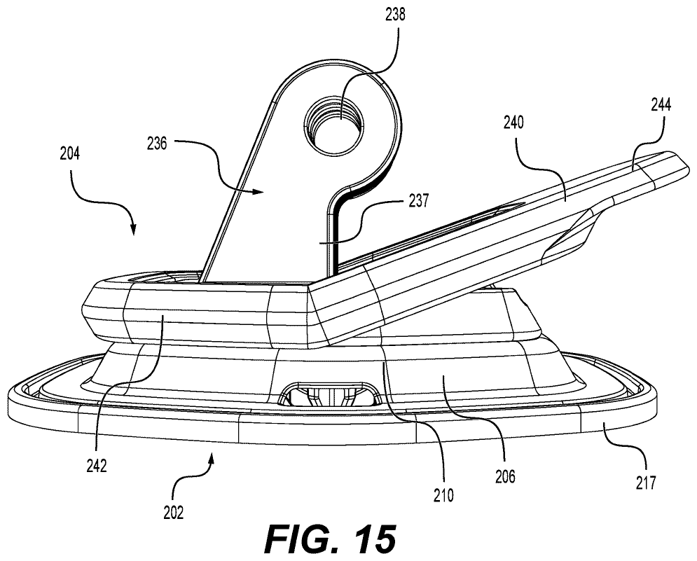

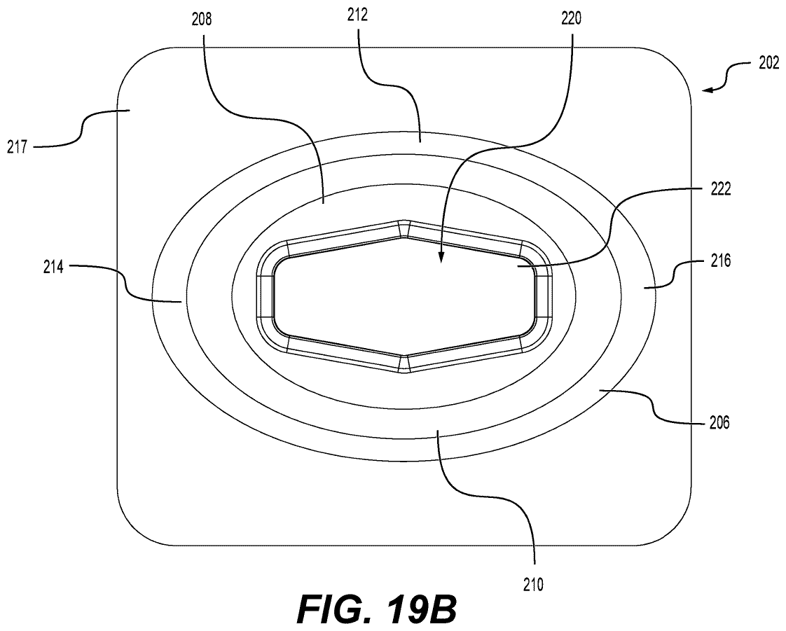

With reference to FIGS. 12 and 13, in this embodiment, the anchor fixture 202 has a fixture body 206 including a top wall portion 208, a front wall portion 210, a rear wall portion 212, a left side wall portion 214 and a right side wall portion 216. Each of the wall portions 208, 210, 212, 214, 216 has an interior surface and an exterior surface. The anchor fixture 202 also has an edge portion 217 that is configured to be fastened to the textile body 79 of the garment 10′. The edge portion 217 is connected to and surrounds a periphery of the fixture body 206 such that the edge portion 217 defines a periphery of the anchor fixture 202. The edge portion 217 may only extend along a portion of the periphery of the fixture body 206 in other embodiments. In this embodiment, the edge portion 217 is made of a soft material which can be helpful to fix the edge portion 217 to the textile body 79. For example, the edge portion 217 may be made of a textile material or an elastomeric material. As such, as best shown in FIGS. 11 and 18, the edge portion 217 can be sewn to the textile body 79 via stitching 85. It is contemplated that the stitching 85 may be replaced by any other fastening connection. For example, the edge portion 217 could instead be glued to the textile body 79.

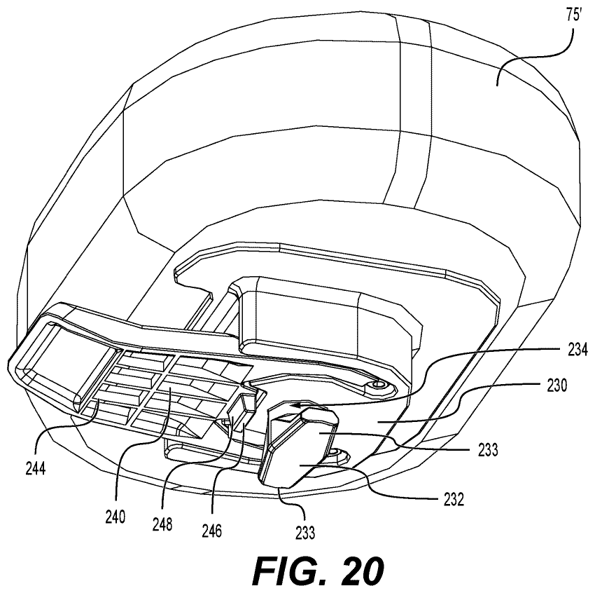

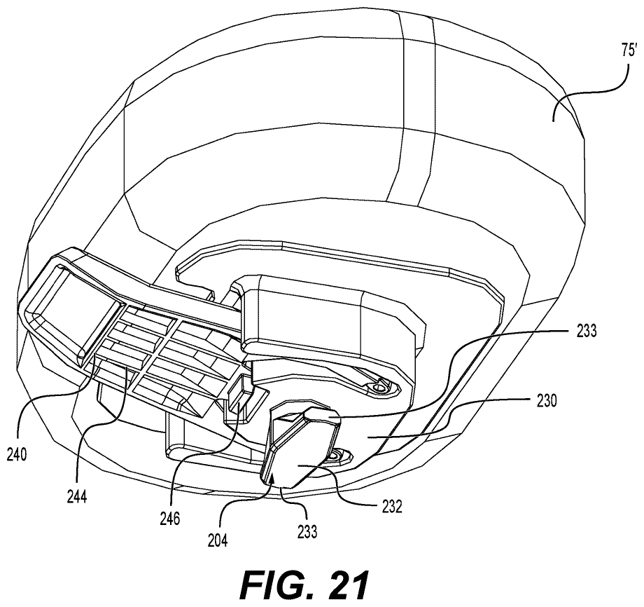

In an alternative embodiment, as shown in FIG. 19A, the anchor fixture 202 could be configured to be otherwise connected to the item 10′. For instance, in this alternative embodiment, the entire anchor fixture 202 is made integrally as a single piece component from a continuous material (e.g., plastic). Thus, in this example, the edge portion 217 forms part of the fixture body 206. In this alternative embodiment, the top wall portion 208 of the fixture body 206 defines four openings 211 which are configured to receive respective fasteners (e.g., bolts, rivets or screws) for fixing the anchor fixture 202 to the item 10′. In another alternative embodiment, as shown in FIG. 19B, the entire anchor fixture 202 is made integrally as a single piece component and the edge portion 217 is configured to be overmolded onto the item 10′. This may be useful for example if at least part of the item 10′ is made by molding such that, upon molding the item 10′, the anchor fixture 202 is overmolded by the material forming the item 10′.

Returning to FIG. 13, the interior surfaces of the wall portions 208, 210, 212, 214, 216 define an anchor chamber 220 that, as will be described in more detail below, is configured to receive therein a part of the anchor 204. The top wall portion 208 also defines an anchor aperture 222 that opens into the anchor chamber 120. As will be described below, part of the anchor 204 is inserted into the anchor chamber 220 through the anchor aperture 222 in order to secure the anchor 204 to the anchor fixture 202. In this embodiment, the fixture body 206 is generally dome-shaped thereby having a concave bottom side and a convex top side, the anchor chamber 220 being defined on the concave bottom side. In use, when the anchor fixture 202 is affixed to the textile body 79, the anchor chamber 220 is thus defined between the surface of the textile body 79 and the wall portions 208, 210, 212, 214, 216. Notably, as shown in FIG. 18, the stitching 85 that affixes the anchor fixture 202 to the textile body 79 surrounds the anchor chamber 220.

As shown in FIG. 13, in this embodiment, the anchor fixture 202 also has two inner interlocking members 221 configured to interlock with a part of the anchor 204 as will be described in greater detail further below. In particular, the interlocking members 221 are protrusions that extend downward from an interior surface 223 of the top wall portion 208. Each interlocking member 221 has a curved portion 225 facing inwardly toward the anchor aperture 222.

Turning now to the anchor 204, with reference to FIGS. 12 and 13, in this embodiment, the anchor 204 has an anchor base 230 and an anchor lock 232 extending below the anchor base 230, spaced therefrom by a gap 234. The anchor base 230 is configured to be connected to a body of the accessory 75′. Notably, the anchor base 230 has an accessory mount 236 that is configured for connection to the body of the accessory 75′. In this embodiment, the accessory mount 236 includes three stands 237 projecting upward from a top surface of the anchor base 230. Each of the stands 237 defines an opening 238. The openings 238 are aligned with one another (i.e., are coaxial) and are configured to receive a fastener (not shown) that engages the accessory 75′. In particular, in this embodiment, the accessory 75′ has two stands defining respective openings and received between the stands 237. The fastener is inserted through the stands 237 and through the stands of the accessory 75′. The accessory 75′ can be made to pivot or not about the fastener by adjusting the tightness with which the fastener is secured (a tighter fastening more greatly limits pivoting of the accessory 75′ about the fastener). The accessory mount 236 may be configured differently in other embodiments.

As best shown in FIG. 13, the anchor lock 232 is connected to the anchor base 230 via a stem 242 defining an axis (not shown). The stem 242 extends downward from the anchor base 230. The anchor lock 232 includes two cams 233 extending from opposite sides of the stem 242 in opposite directions from each other. In this embodiment, each of the cams 233 defines a recess 239 at an end of the cam 233. The recesses 239 are configured to receive respective ones of the interlocking members 221 as will be described in more detail below. As will be appreciated, unlike the anchor 104 described above, in this embodiment, the anchor 204 does not have a lever to rotate the anchor lock 232. Rather, the anchor base 230 and anchor lock 232 move together. As such, when the anchor lock 232 is rotated between an unlocked position and a locked position, as will be explained further below, the anchor base 230 describes the same rotation. Therefore, the entirety of the anchor 204 is rotated in order to rotate the anchor lock 232 between the unlocked and locked positions.

As shown in FIGS. 12 and 13, in this embodiment, the anchor 204 also has a movable latch 240 that is operable by the user to keep the anchor lock 232 in the locked position when it is disposed within the anchor chamber 220. The latch 240 has a latch body 242 that is connected to and surrounds the anchor base 230. The latch body 242 may only extend along a part of the periphery of the anchor base 230 in other embodiments. In this embodiment, the latch body 242 includes a handle 244 for handling by the user to actuate the latch 240. As shown in FIG. 13, the latch 240 has a latching feature 246 for engaging the anchor fixture 202 to prevent rotation of the anchor lock 232 from the locked position to the unlocked position as will be described in greater detail below. In this embodiment, the latching feature 246 includes a latching protrusion 248 that is selectively insertable within the anchor aperture 222. The handle 244 is operatively connected to the latching protrusion 248 via the latch body 242 such that lifting and lowering the handle 244 causes the latching protrusion 248 to be lifted and lowered accordingly. The manner in which the latching protrusion 248 interacts with the anchor fixture 202 will be described in more detail below.

In this embodiment, the latch 240 is made of an elastomeric material (e.g., rubber). It is contemplated that the latch 240 could be made of other materials in other embodiments.

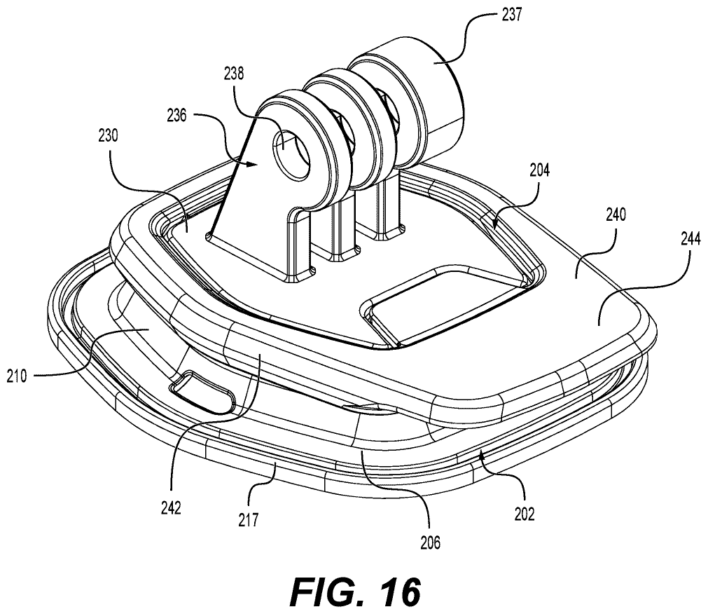

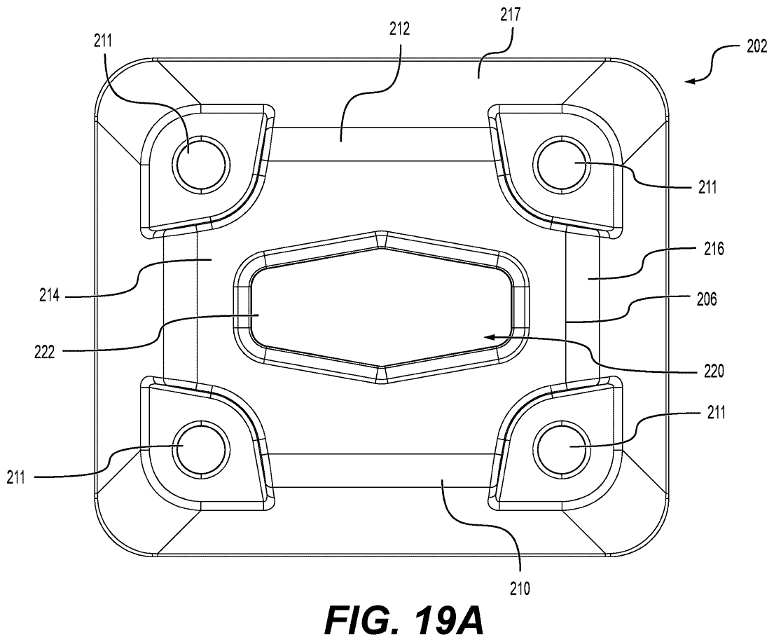

In order to secure the anchor 204 to the anchor fixture 202, the anchor 204 is first oriented such that the anchor lock 232 is in the unlocked position as shown in FIGS. 12 and 13. The anchor lock 232 is then inserted through the anchor aperture 222 and into the anchor chamber 220 of the anchor fixture 202. The anchor lock 232 is thus disposed in the anchor chamber 220 but is still in the unlocked position and thus free to pass through the anchor aperture 222, as illustrated for example in FIG. 14. The entirety of the anchor 204 is then rotated in order to rotate the anchor lock 232 to the locked position, as shown in FIG. 17. As will be appreciated, since the anchor 204 is fixed to the accessory 75, the accessory 75 is rotated together with the anchor 204 when the anchor 204 is rotated between the unlocked and locked positions. As shown in FIG. 17, in the locked position, the anchor lock 232 is disposed in the anchor chamber 220 and prevented by the anchor fixture 202 (namely by the top wall portion 208) from passing through the anchor aperture 222. In this embodiment, when the anchor lock 232 is rotated to the locked position, the interlocking members 221 of the anchor fixture 202, which are fixed and disposed within the anchor chamber 220, engage the cams 233 of the anchor lock 232. More specifically, the curved portion 225 of each interlocking member 221 is received in a corresponding recess 239 of one of the cams 233. The anchor lock 232 thus snaps into place when the curved portions 225 are moved into the recesses 239.

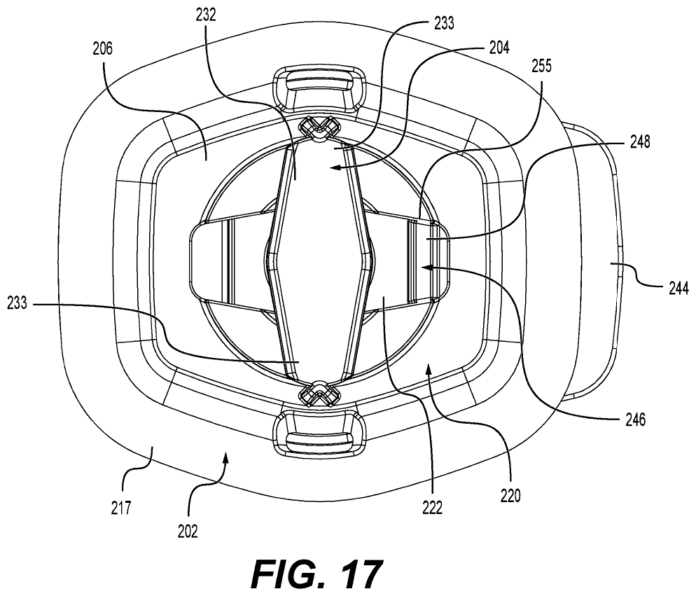

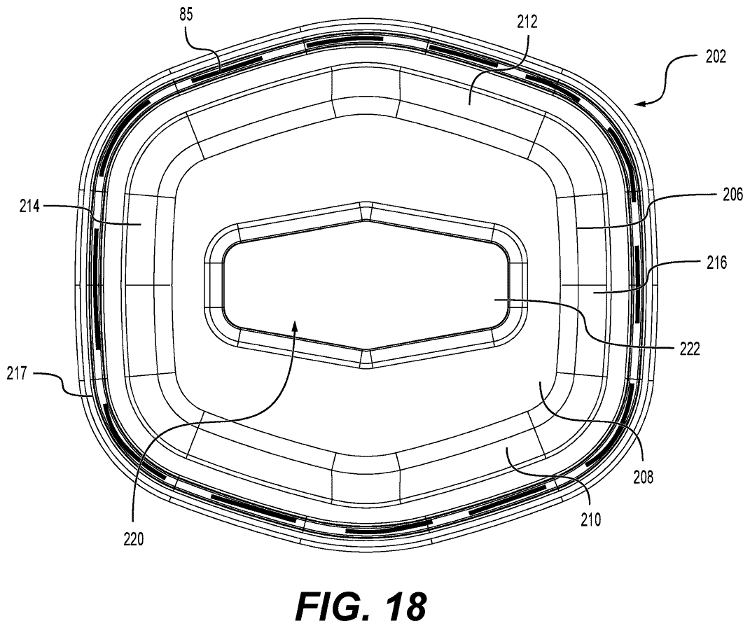

At this point, the anchor 204 is in the position shown in FIG. 15, with the latch handle 244 being lifted such that the latching protrusion 248 is not in engagement with the anchor fixture 202. As shown in FIGS. 16 and 17, in order to further secure the anchor lock 232 in the locked position, the user lowers the handle 244 which causes the latching protrusion 248 to be inserted into the anchor aperture 222. As shown in FIG. 17, the latching protrusion 248 is shaped and dimensioned such that, when it is inserted into the anchor aperture 222, the latching protrusion 248 is in contact with part of an inner edge portion 255 of the top wall portion 208 defining the anchor aperture 222 such as to wedge the anchor lock 232 in the locked position. As such, the latching protrusion 248 thereby prevents the anchor lock 232 from moving to the unlocked position. This may be helpful to ensure that the anchor lock 232 remains in the locked position even when it is subjected to significant vibrations (e.g., if the user is wearing the garment 10′ while driving a snowmobile). It is contemplated that, in other embodiments, an aperture defined by the anchor fixture 202 and different from the anchor aperture 222 could receive the latching protrusion 248.

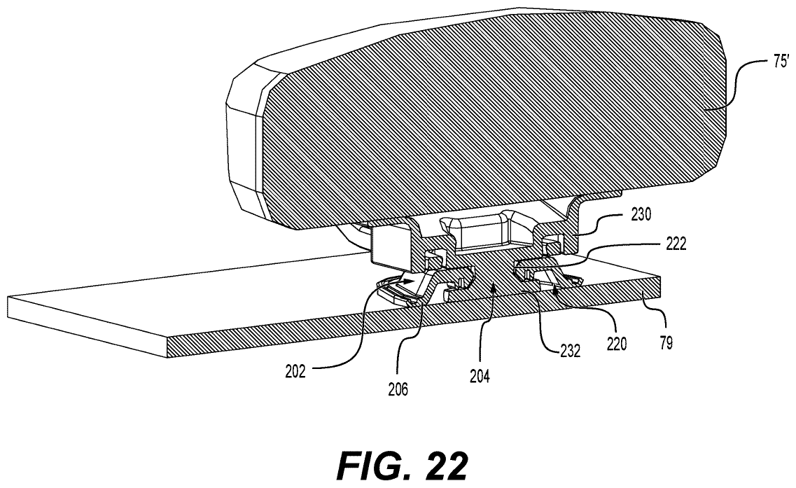

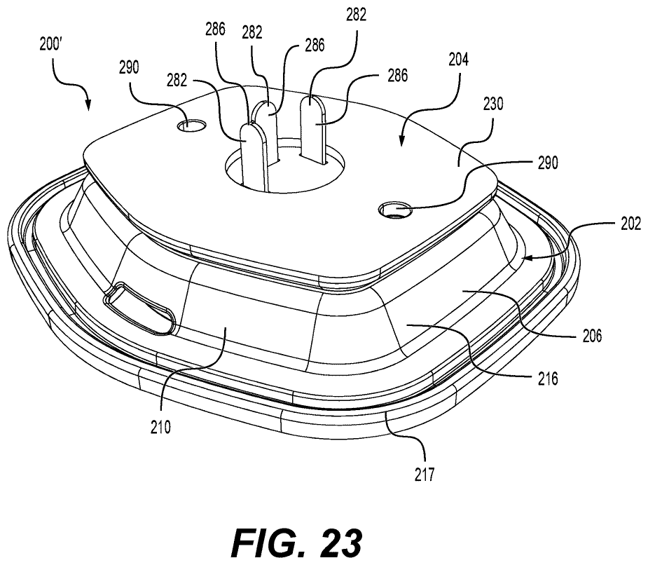

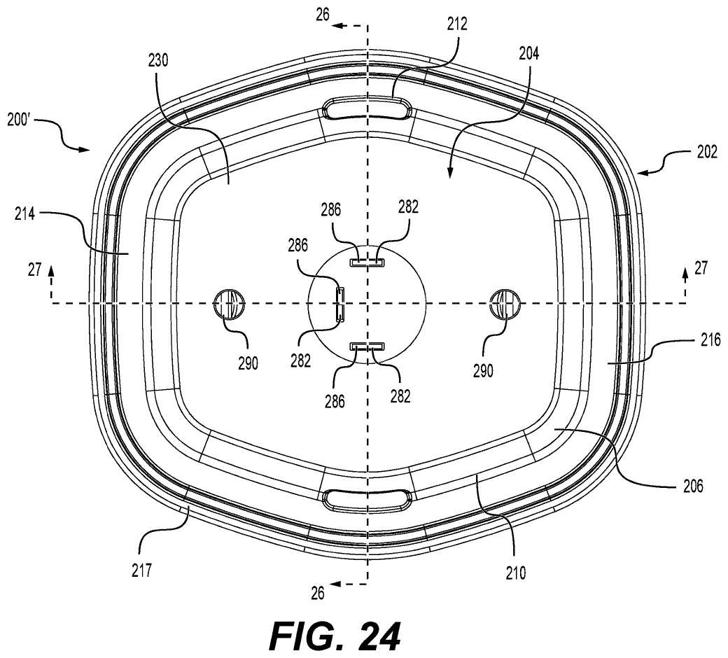

The anchor 204 may also be configured differently in other embodiments. For instance, an alternative embodiment of the anchor 204 attached to the accessory 75′ is illustrated in FIGS. 20 to 22. In this embodiment, the anchor 204 does not include the stands 237 described above. Instead, the anchor base 230 is connected to the accessory 75′ via fasteners and/or glue, or the anchor base 230 could be molded onto a bottom of the body of the accessory 75′. In addition, as can be seen, the handle 244 of the latch 240 extends further outwards from the anchor base 230 to accommodate the size of the accessory 75′.

It is contemplated that, in other embodiments, the anchor 204 may be instead be connected to the textile body 79 of the garment 10′ while the anchor fixture 202 is connected to the accessory 75′. For instance, in such embodiments, the anchor 204 could have an edge portion similar to the edge portion 217 described above with respect to the anchor fixture 202.

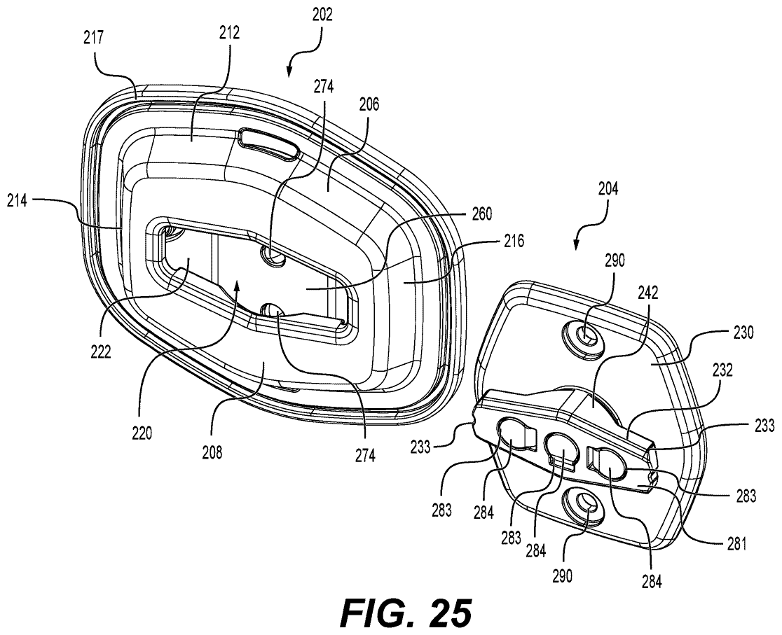

Referring back to FIG. 10, according to another embodiment, a system 200′ is provided that is similar to the system 200 described above. Therefore, in FIGS. 23 to 28 which illustrated the system 200′, the same reference numbers as used in the description of the system 200 have been used to designate equivalent components of the system 200′. Only the differences between the system 200′ and the system 200 will thus be described herein. As will be explained below, one of the main differences between the systems 200, 200′ is that the anchor fixture 202 and the anchor 204 of the system 200′ are configured to be electrically connected to one another in order to power the accessory 75′.

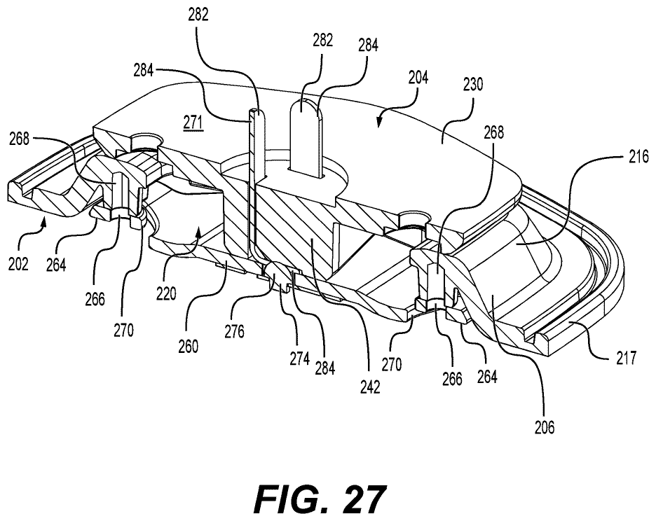

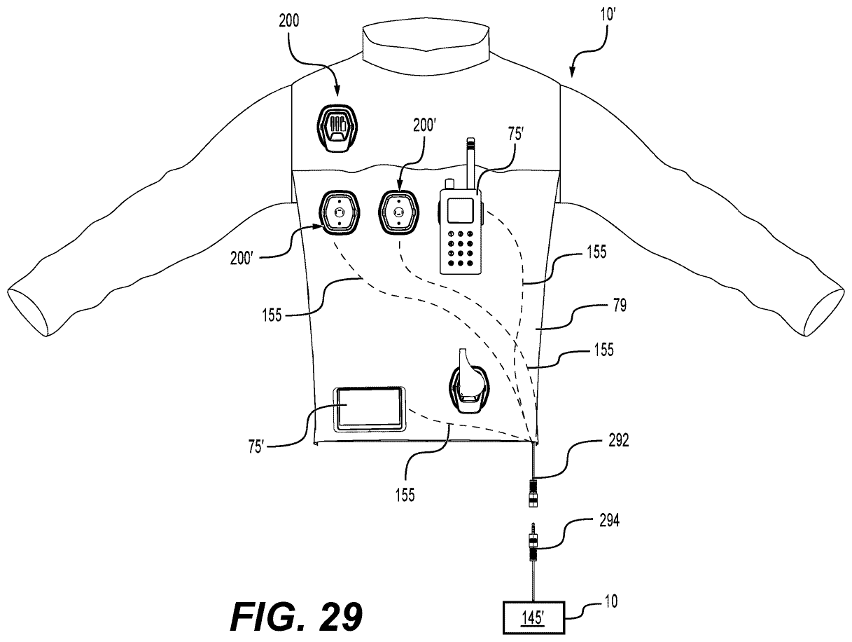

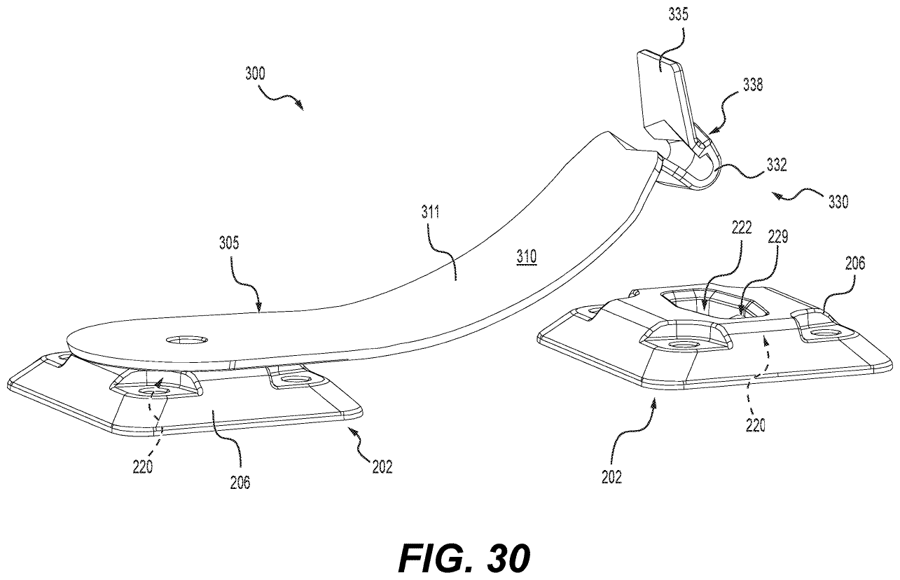

With reference to FIGS. 25 to 28, in this embodiment, the anchor fixture 202 of the system 200′ includes a backing member 260 connected to the fixture body 206. Together with the wall portions 208, 210, 212, 214, 216 of the fixture body 206, the backing member 260 defines the anchor chamber 220. That is, at least part of the anchor chamber 220 is defined between the backing member 260 and the fixture body 206. As best shown in FIG. 28, the backing member 260 has a body 262 which, in this example, is generally circular. It is contemplated that the body 262 may have any other suitable shape in other embodiments. In this embodiment, the body 262 defines two flange portions 264 on opposite sides of the body 262 configured for connection to the fixture body 206. Notably, the flange portions 264 define respective openings 266 for receiving fasteners (not shown) that connect the backing member 260 to the fixture body 206. In particular, the fasteners extend through the openings 266 and into respective openings 268 (FIGS. 27, 28) defined by the fixture body 206. The openings 268 are threaded to securely receive the fasteners therein. As shown in FIGS. 27 and 28, in this embodiment, the body 262 of the backing member 260 also defines two semi-circular slots 270 that partially surround respective ones of the openings 266. The semi-circular slots 270 afford some flexibility to the flange portions 264.

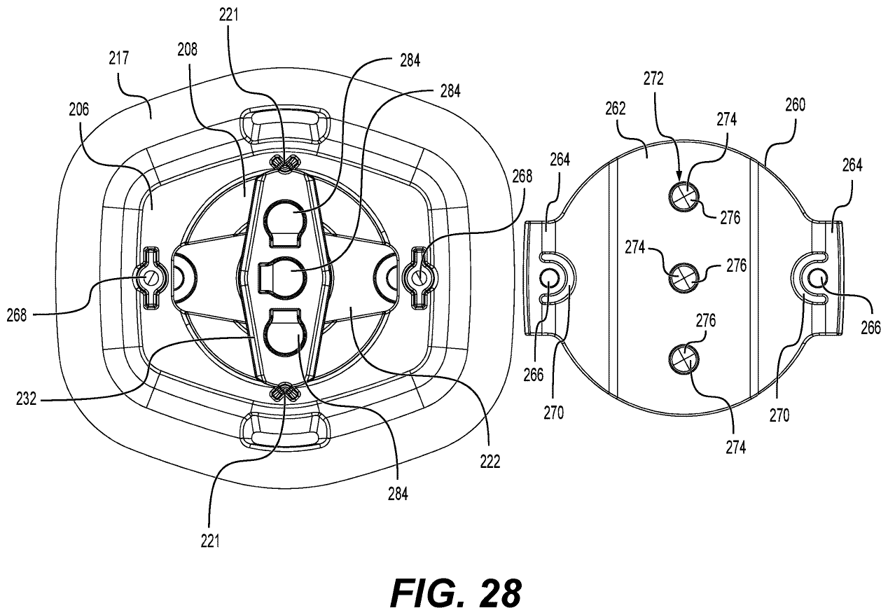

As shown in FIGS. 26 to 28, the backing member 260 also has a fixture electrical element 272 that is configured to electrically connect the anchor fixture 202 to the anchor 204 as will be described in more detail below. In this embodiment, the fixture electrical element 272 includes three electrical contacts 274 that are arranged in a row and. Each of the electrical contacts 274 has a dome-shaped contact portion 276 and a connecting portion 278 extending below the contact portion 276. The contact portion 276 protrudes from a top surface of the body 262 of the backing member 260. As such, the contact portion 276 is disposed within the anchor chamber 220. The connecting portion 278 is configured to be electrically connected to a power source 145′ (FIG. 10). Notably, as shown in FIG. 10, wiring 155 connects each of the anchor fixture 202 of the systems 200′ to the power source 145′ which is supported by the textile body 79 of the garment 10′. In this embodiment, the power source 145′ is a portable battery pack. It is contemplated that the power source 145′ could be any other suitable power source in other embodiments.

Referring now to FIGS. 23 to 25, the anchor 204 of the system 200′ has an anchor electrical element 280 that is configured to contact the fixture electrical element 272. In this embodiment, the anchor electrical element 280 includes three conducting members 282 that extend at least partly through the anchor base 230 and through the anchor lock 232. Notably, as best shown in FIG. 25, each of the conducting members 282 has a contact portion 284 that is exposed at a lower surface 281 of the anchor lock 232. In particular, the lower surface 281 of the anchor lock 232 defines three openings 283 in which the contact portions 284 of the conducting members 282 are disposed. In this embodiment, the contact portions 284 are formed by bending of the conducting members 282 which provides the contact portions 284 with a certain flexibility to deflect upon coming into contact with the electrical contacts 274. As best shown in FIGS. 26 and 27, from the anchor lock 232, the conducting members 282 extend upwardly through the stem 242 of the anchor 204 and protrude from a top surface 271 of the anchor base 230. In particular, each of the conducting members 282 has a connecting portion 286 that protrudes upward from the top surface 271 of the anchor base 280. The connecting portion 286 is configured to conduct electricity to a power circuit of the accessory 75′. Notably, the connecting portions 286 form three prongs that are receivable by corresponding receptacles defined by the accessory 75′.

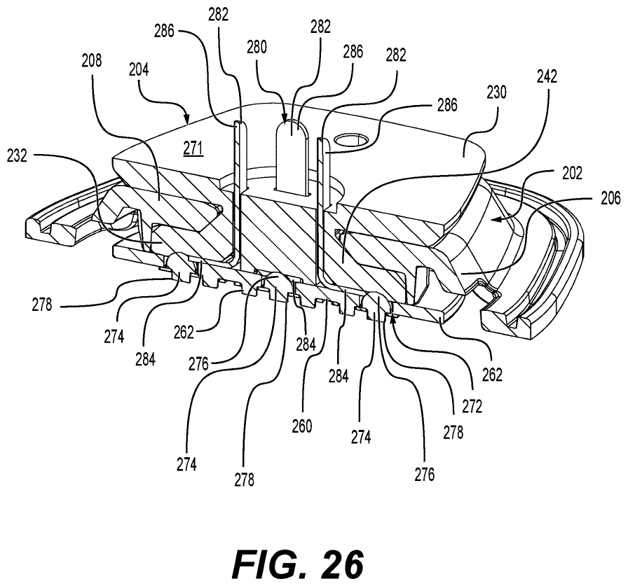

As will be appreciated, in this embodiment, the accessory mount 236 previously described is omitted. Rather, the accessory base 230 is connected to the accessory 75′ via fasteners (not shown) received by openings 290 (FIGS. 23, 24) defined by the anchor base 230. The anchor 204 may be connected to the accessory 75′ in any other suitable way.

In order to secure the anchor 204 to the anchor fixture 202 of the system 200′, the anchor 204 is first oriented such that the anchor lock 232 is in the unlocked position. The anchor lock 232 is then inserted through the anchor aperture 222 and into the anchor chamber 220 of the anchor fixture 202. The anchor lock 232 is thus disposed in the anchor chamber 220 but is still in the unlocked position and thus free to pass through the anchor aperture 222. The entirety of the anchor 204 is then rotated in order to rotate the anchor lock 232 to the locked position, shown in FIGS. 26 to 28. As will be appreciated, since the anchor 204 is fixed to the accessory 75′, the accessory 75′ is rotated together with the anchor 204 when the anchor 204 is rotated between the unlocked and locked positions. In the locked position, the anchor lock 232 is disposed in the anchor chamber 220 and prevented by the anchor fixture 202 (namely by the top wall portion 208) from passing through the anchor aperture 222. Upon doing so, the anchor electrical element 280 comes into contact with the fixture electrical element 272. Notably, the contact portions 276, 284 are aligned and come into contact with one another to establish electrical communication therebetween. As such, since the anchor electrical element 280 is electrically connected to the accessory 75′ while the fixture electrical element 272 is electrically connected to the power source 145′, the accessory 75′ is electrically connected to the power source 145′ via the anchor 204 and the anchor fixture 202.

Similarly to the system 200, the roles of the anchor 204 and the anchor fixture 202 may be reversed in other embodiments, with the anchor 204 connected to the textile body 79 and the anchor fixture 202 connected to an accessory body of the accessory 75′.

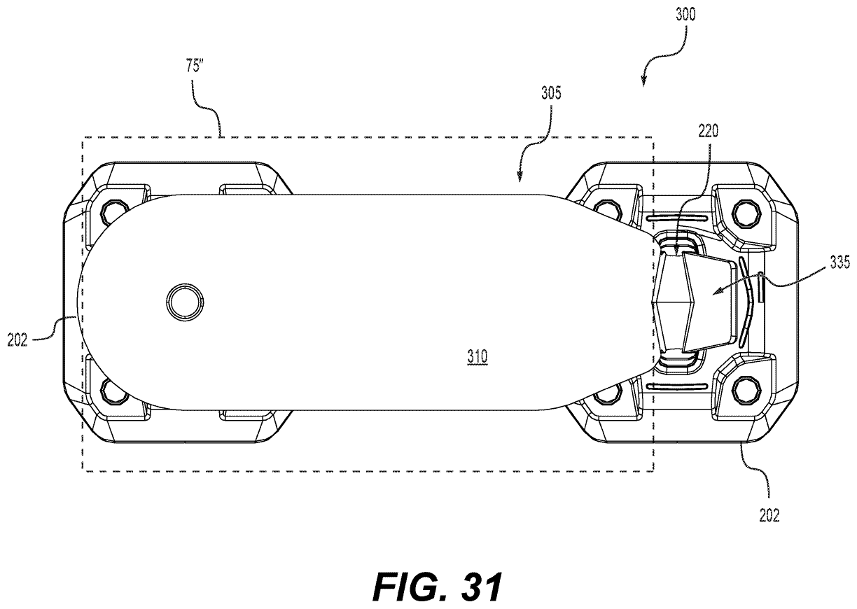

With reference to FIG. 29, according to an alternative embodiment, the power source 145′ may be external to the garment 10′. Notably, in this alternative embodiment, the wiring 155 electrically connects the anchor fixtures 202 of the various systems 200′ to a garment power connector 292 of the garment 10′ that is configured to be mated with an external connector 294. In this embodiment, the garment power connector 292 is a receptacle and the external connector 294 is a plug that is received within the garment power connector 292. The external connector 294 is itself electrically connected to the power source 145′ which, in this alternative embodiment, is a battery of the snowmobile 10. Other types of power sources are also contemplated.

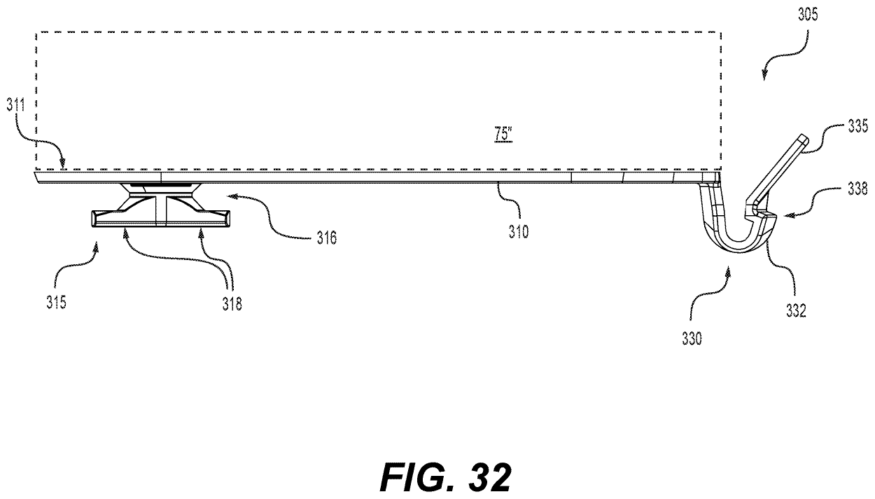

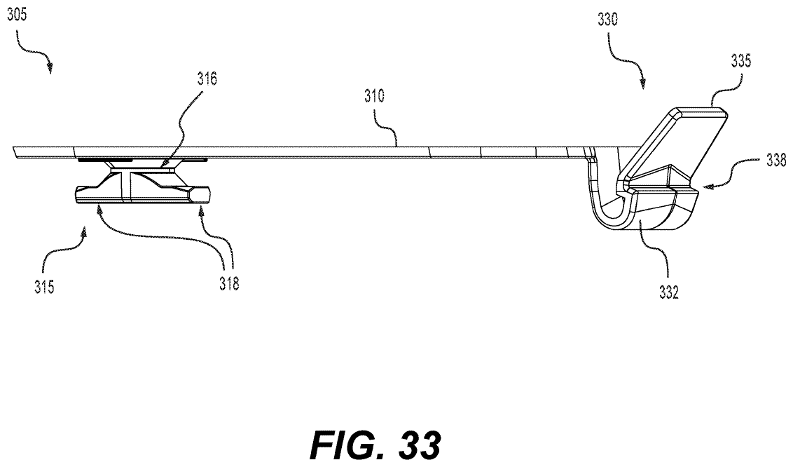

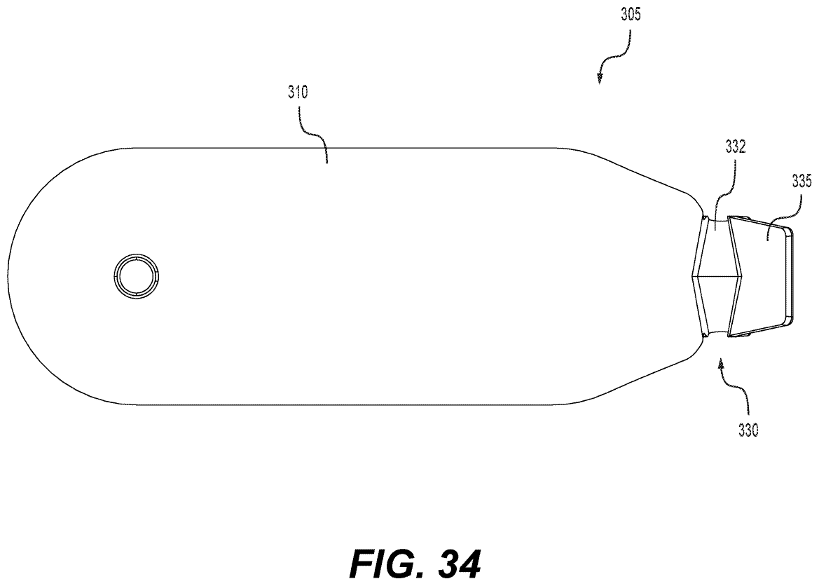

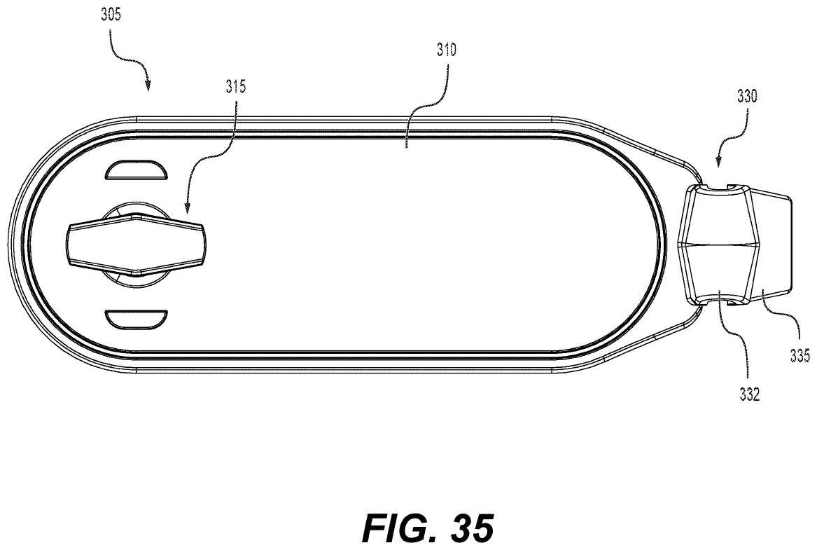

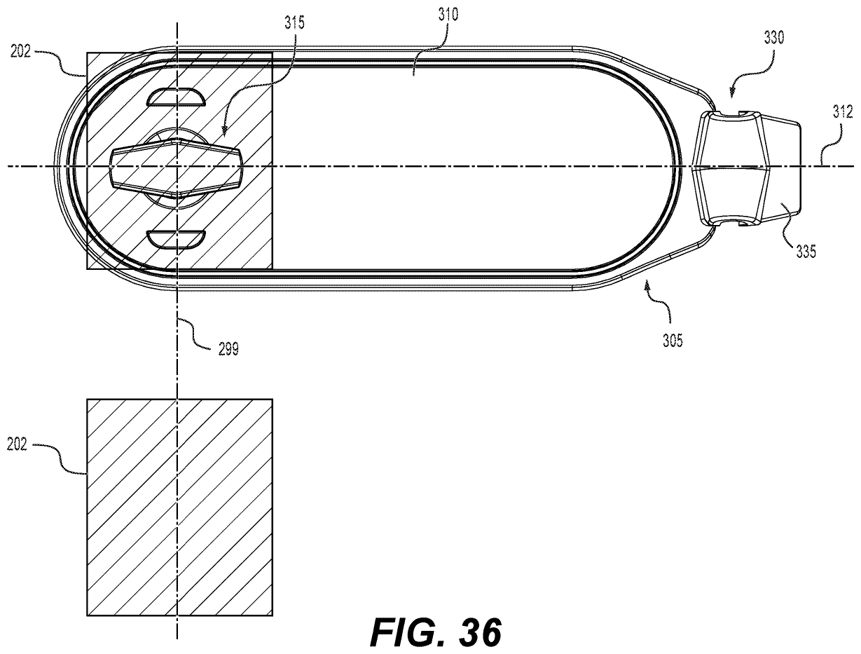

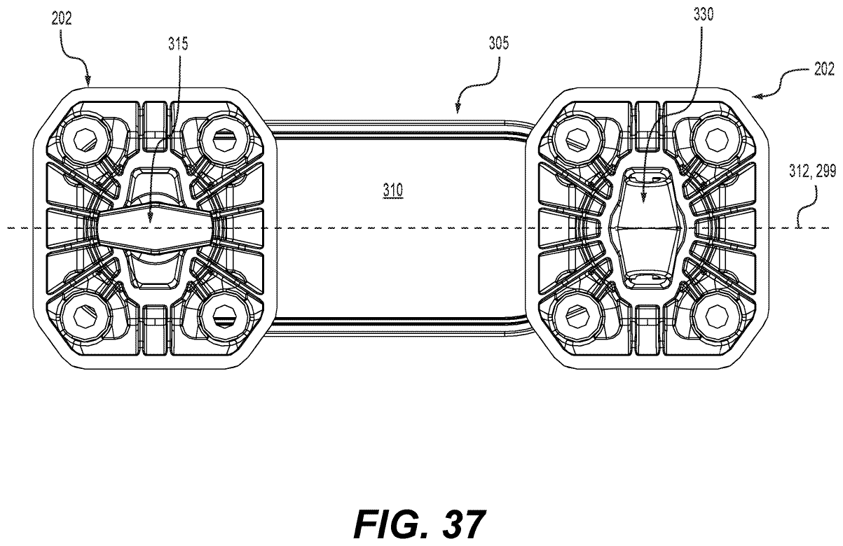

Another non-limiting embodiment of a system 300 for connecting an accessory to an item is illustrated in FIGS. 30 to 37. The system 300 is schematically illustrated connecting a container accessory 75″ in FIGS. 31 and 32, for example for connecting to the snowmobile 10 or the garment 10′. It is contemplated that the system 300 could be used for connecting a variety of accessories to a variety of items.

The system 300 includes two anchor fixtures 202 configured to be connected to the item. The anchor fixtures 202 of the system 300 are generally the same anchor fixtures 202 illustrated and described with reference to FIG. 19A. Therefore, detailed description of the anchor fixtures 202 will not be repeated here. It is contemplated that some details of the anchor fixtures 202 of the system 300 could vary. It is further contemplated that the anchor fixtures 202 could be omitted in some embodiments, for example where an item has an anchor chamber and aperture formed therein. For reference and as is described above, each anchor fixture 202 defines an anchor chamber 220 and an anchor aperture 222 opening into the anchor chamber 220.

The system 300 also includes an attachment base 305 for connecting to the two anchor fixtures 202 when in use. The attachment base 305 includes and is generally formed by a base body 310 configured to be connected to the accessory. In the schematic example in FIGS. 31 and 32, a connection surface 311 of the base body 310 is glued or sewn to the accessory 75″. The base body 310 is at least partially formed from a flexible material, such as flexible plastic or rubber. As is illustrated in FIG. 30, this permits the base body 310 to flex when moving between locked and unlocked positions of the system 300, as will be described in more detail below.

The attachment base 305 includes a snap joint 330 attached to the base body 310 at one end portion thereof. The base body 310 and the snap joint 330 are integrally formed in the present embodiment. It is contemplated that the snap joint 330 could be separately formed and subsequently attached to the base body 310 in some embodiments. The snap joint 330 is shaped and adapted for selectively inserting into the anchor aperture 222 of one of the anchor fixtures 202, as will be described in additional detail below.

In the illustrated embodiment, the snap joint 330 is specifically a U-shaped snap fit joint 330. The U-shaped snap fit joint 330 includes a U-shaped body 332 shaped and arranged to be inserted into the anchor aperture 222. The U-shaped body 332 includes a ridge 338 on an exterior side thereof, also referred to as a lip 338. The ridge 338 selectively abuts the anchor aperture 222 when the system 300 is in the locked position. One end of the U-shaped body 332 is connected to the base body 310. The snap fit joint 330 also includes a tab 335 connected to and extending from an opposite end of the U-shaped body. Use of the ridge 338 and the tab 335 of the U-shaped snap fit joint 330 is described further below.

The attachment base 305 further includes an anchor lock 315 attached to the base body 310 near an end portion thereof, generally opposite the snap joint 330. The anchor lock 315 is shaped and arranged to be selectively inserted into one of the anchor fixtures 202, described further below. The anchor lock 315 is connected to the base body 310 via a stem 316. The anchor lock 315 includes two cams 318 extending from opposite sides of the stem 316. In the present embodiment, the base body 310 and the anchor lock 315, as well as the snap joint 330, are integrally formed. It is contemplated that the anchor lock 315 could be separately formed and then subsequently connected to the base body 310 is some embodiments.

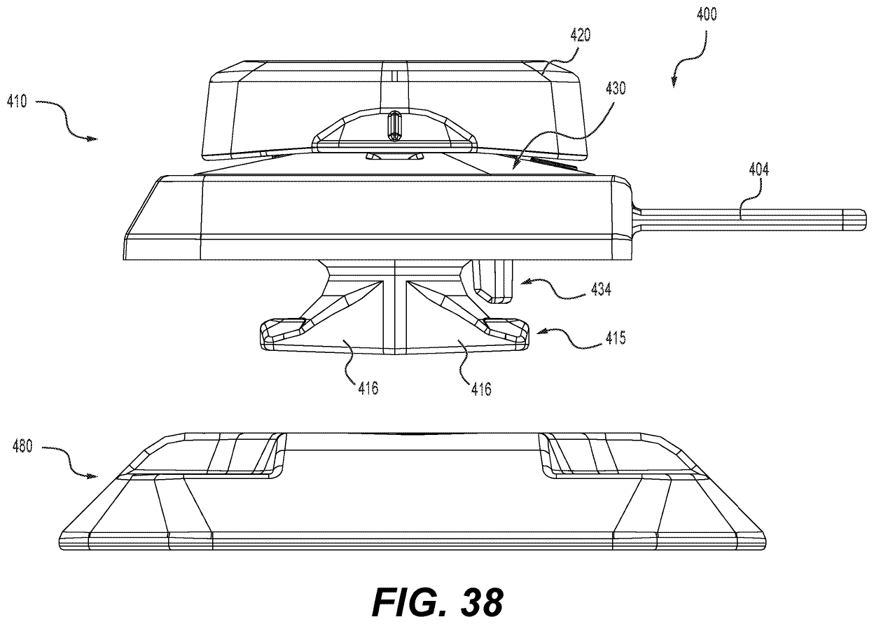

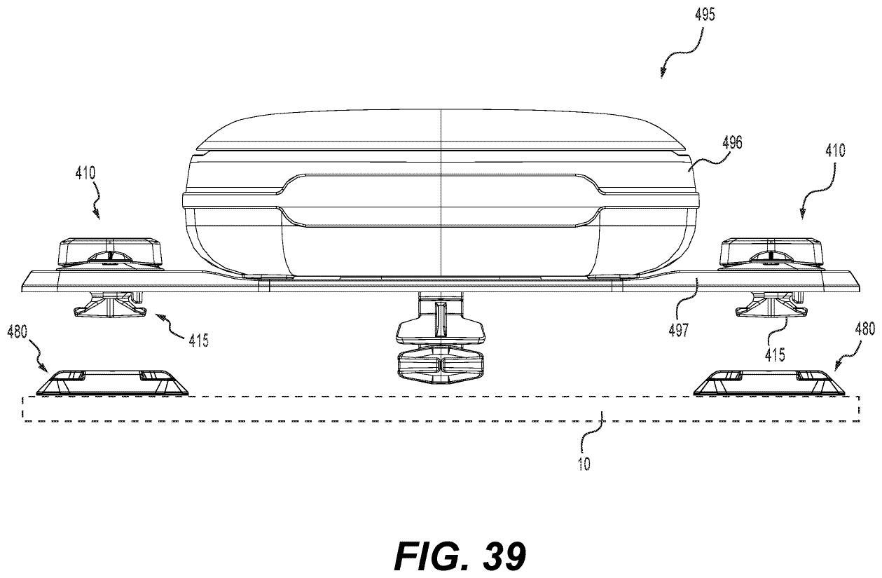

The attachment base 305 is selectively moveable between an unlocked position and a locked position, and vice versa. Specifically, the anchor lock 315, when inserted into the anchor aperture 222, is rotatable relative to the corresponding anchor fixture 202 between the unlocked position, FIGS. 31 and 37, and the locked position, shown schematically in FIG. 36. In the locked position, the attachment base 305 is selectively connected to the anchor fixtures 202 at both ends of the attachment base 305.

More specifically, in the locked position, the anchor lock 315 is disposed in the anchor chamber 220 of one anchor fixture 202, the anchor lock 315 being prevented by the anchor fixture 202 from passing through the anchor aperture 222. Further in the locked position, the snap joint 330 is generally aligned with the anchor aperture 222 of the other anchor fixture 202 and is selectively inserted therein. As is shown in FIG. 37, when in the locked position, a long axis 312 of the attachment base 305 is positioned parallel to a line 299 extending through the centers of the anchor apertures 222 of the anchor fixtures 202.

As is noted above and illustrated in FIG. 30, the base body 310 is at least partially flexible, which permits the snap joint 330 to be selectively inserted into and removed from the anchor aperture 222 when the anchor lock 315 is in the locked position. When the snap joint 330 is inserted into the anchor aperture 222, a top edge of the ridge 338 abuts an edge 229 of the anchor aperture 222 to selectively maintain the snap joint 330 in the anchor fixture 202. To remove the snap joint 330 from the anchor aperture 222, the tab 335 is bent to bring the tab-connected end of the U-shaped body 332 toward the base body-connected end of the U-shaped body 332, thereby permitting the ridge 338 to pass the edge of the anchor aperture 222. The snap joint 330 is then pulled generally upward, flexing the base body 310, in order to fully disengage from the anchor fixture 202. The attachment base 305 is then rotated a quarter-turn in order to align the anchor lock 315 with the anchor aperture 222. As the anchor lock 315 is rotationally fixed relative to the base body 310 and the snap joint 330, an entirety of the attachment base 305 is rotated with the anchor lock 315 to move the anchor lock 315 between the unlocked position and the locked position, and vice versa.

In the unlocked position, the anchor lock 315 is free to pass through the anchor aperture 222 and the snap joint 330 is misaligned with the corresponding anchor fixture 202. As is shown in FIG. 36, when in the unlocked position, the long axis 312 of the attachment base 305 is positioned perpendicular to the line 299 extending through centers of the anchor apertures 222 of the anchor fixtures 202 as installed for use in the system 300.

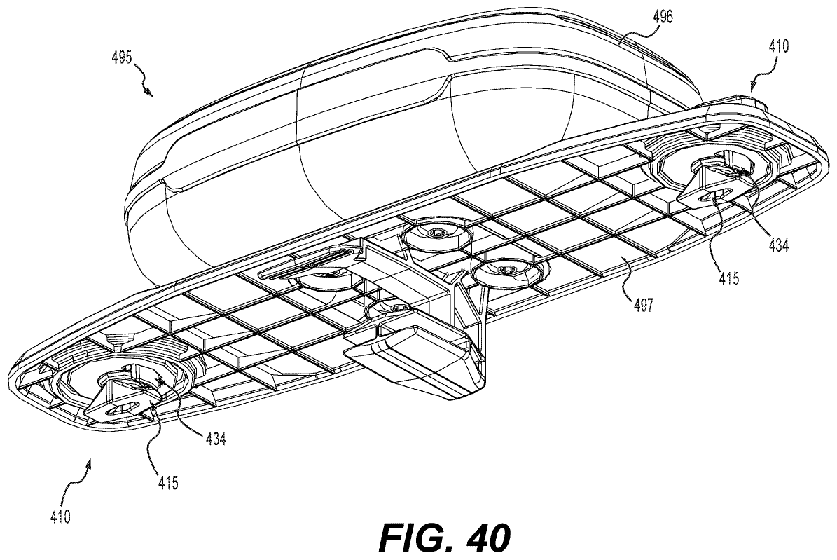

With reference to FIG. 38, another non-limiting embodiment of a system 400 for connecting an accessory to an item is illustrated.

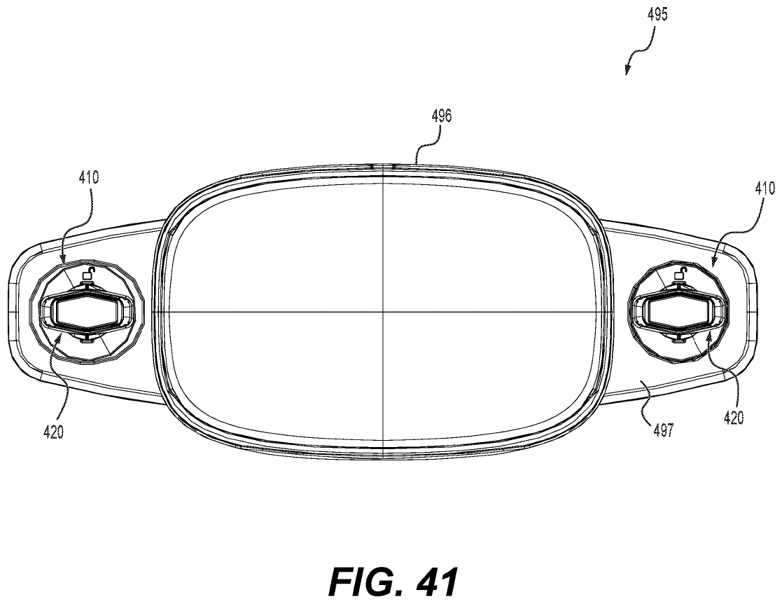

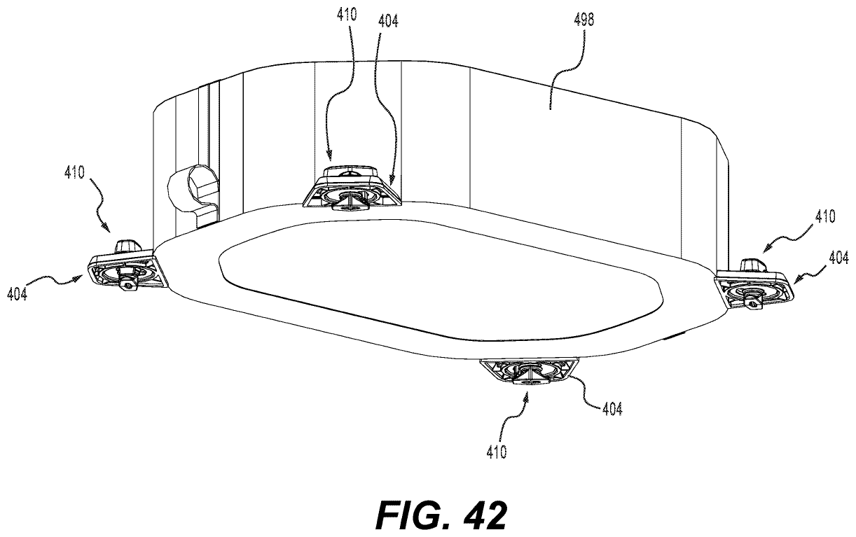

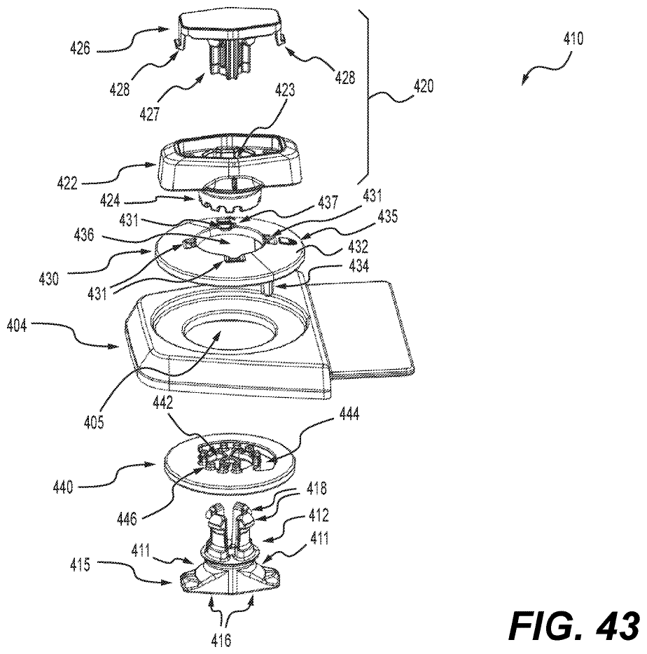

The system 400 is illustrated connecting a storage accessory 495 in FIGS. 39 to 41 to the snowmobile 10 (shown schematically in FIG. 39). The storage accessory 495 includes a storage box 496 and a platform 497 to which the storage 496 is connected. The system 400 selectively connects the storage accessory 495 to the snowmobile 10 by selectively connecting anchors 410 connected to the storage accessory 495 to anchor fixtures 480 connected to the snowmobile 10, details of which are described below. In another non-limiting example, the anchors 410 are illustrated connected to a bag accessory 498 for selectively connecting the bag 498 to an item such as the snowmobile 10. As will be described further below, multiple anchor bases 404 are connected to the bag 498, the anchors 410 being connected to the anchor bases 404. It is contemplated that the system 400 could be used for connecting a variety of other accessories to a variety of items, including but not limited to the snowmobile 10 and the garment 10′.

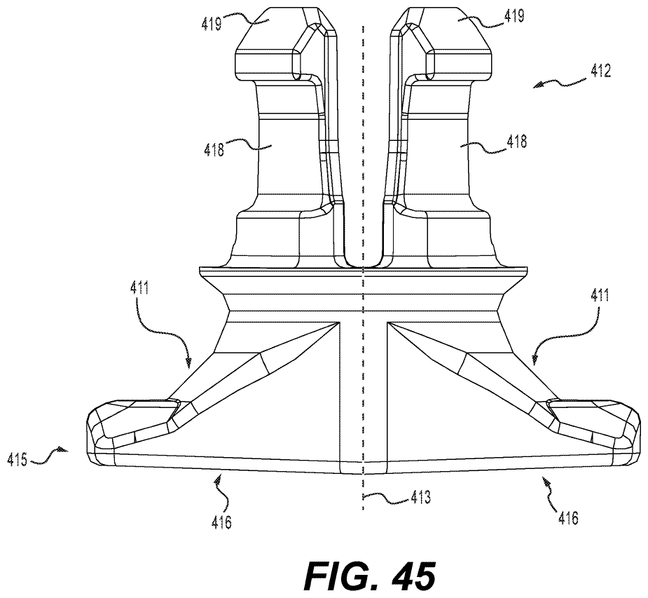

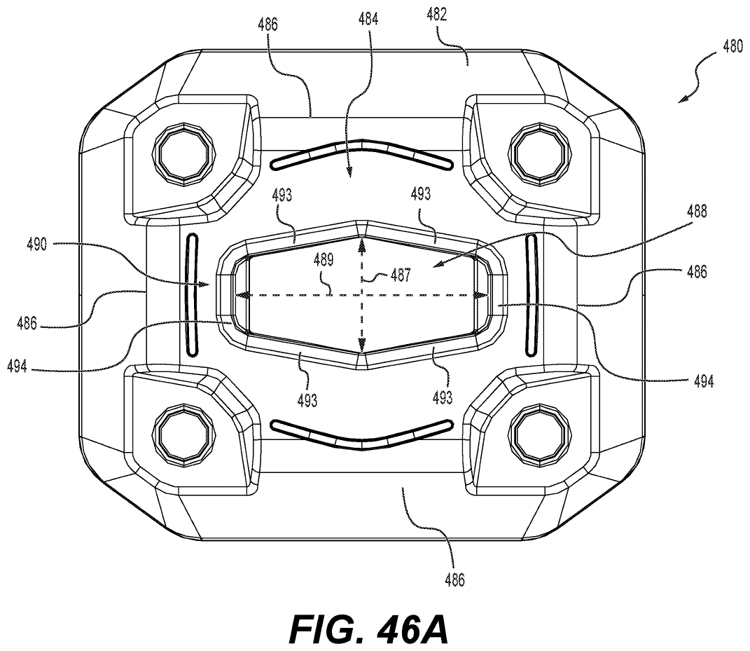

With additional reference to FIGS. 43 and 44 and as briefly mentioned above, the system 400 includes the anchor 410 and the anchor fixture 480. A portion of the anchor 410 is selectively received in the anchor fixture 480 for selectively connecting an accessory connected to the anchor 410 to an item connected to the anchor fixture 480. The reverse arrangement is also possible in at least some embodiments, where the anchor fixtures 480 could be connected to an accessory to selectively connect to an item connected to the anchor 410.

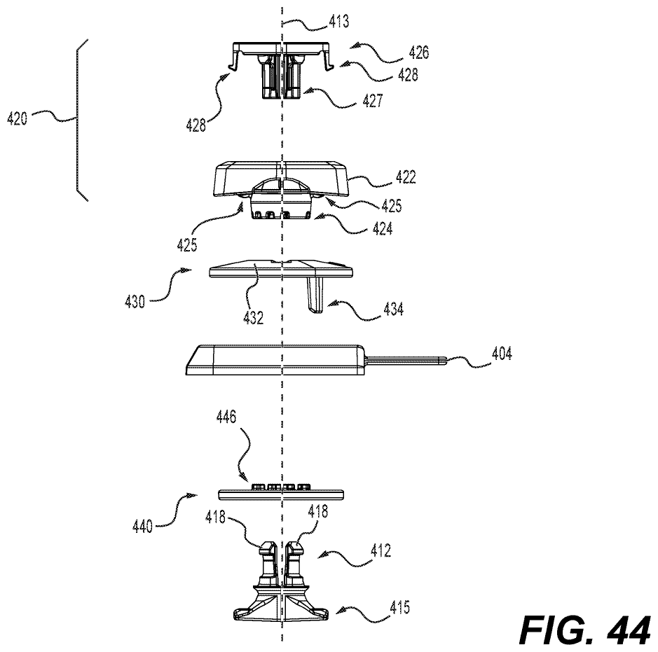

The system 400 also includes the anchor base 404 for connecting the anchor 410 to an accessory in at least some embodiments. The anchor base 404 is configured to be connected to either the accessory or the item. It is further contemplated that the anchor 410 (with or without the anchor base 404) and the anchor fixture 480 could connected to two accessories, in order to connect two accessories together. As is illustrated in FIG. 42 as one non-limiting example, four anchor bases 404 are connected to the bag 498. The anchor base 404 defines a base aperture 405 therein. As will be described in more detail below, the anchor 410 is rotationally connected to the anchor base 404, with a portion of the anchor 410 extending through the base aperture 405. It is noted that while the system 400 is generally described herein using the anchor base 404, the anchor base 404 may be omitted in some non-limiting embodiments, with a portion of the accessory providing a base structure for receiving the anchor 410 therethrough. See for example the embodiment illustrated in FIGS. 39 to 41, where the platform 497 receives the anchors 410 without use of the anchor base 404.

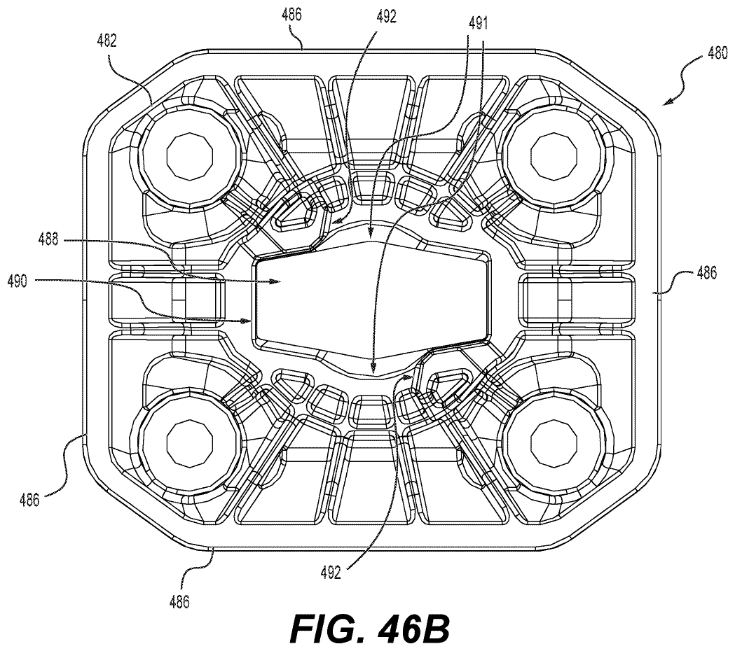

With additional reference to FIG. 45, the anchor 410 has an anchor stem 412 and an anchor lock 415 connected to one end of the stem 412. The anchor stem 412, also referred to as the stem 412, defines an axis 413 about which the anchor lock 415 is rotated during use. The anchor lock 415 includes two cams 416 extending from opposite sides of the stem 412. In the illustrated embodiment, the stem 412 and the anchor lock 415 are integrally connected. In different embodiments, the anchor lock 415 could be differently connected to the stem 412.

As is best seen in FIG. 45, the anchor lock 415 further has one or more protrusions extending therefrom for selectively engaging with a surface of the anchor fixture 480 when in the locked position. In the illustrated embodiment, the anchor lock includes a protrusion 411 extending from each cam 416, generally in the form of a conic, bulbous or protruding surface curving out from the junction of the corresponding cam 416 with the stem 412. It is contemplated that the protrusions 411 could take different forms, for example as ridges or bumps on a lever-side surface of the cams 416. Use of the protrusions 411 is described in more detail below.

The anchor 410 also includes a lever 420 connected to the stem 412. The lever 420 allows a user to rotate the stem 412 about the axis 413, thereby rotating the anchor lock 415. In particular, the anchor lock 415 is rotatable about the axis 413 by using the lever 420 between locked and unlocked positions, described further below.

In the present embodiment, the lever 420 includes a handle portion 422 forming the ergonomic portion of the lever 420. The handle portion 422, also referred to as the handle 422, has a passage 423 defined therethrough. One end portion of the handle 422 has a plurality of slots 424 defined therein for engaging with a lock washer 440, described further below. It is contemplated that the lever 420 could be a single integral component in some embodiments, with or without slots defined therein. In the present embodiment, the lever 420 also includes a lever insert 426 disposed at least partially in the passage 423 of the handle 422. The lever insert 426 has an end portion 427 engaged with the stem 412 inside the passage 423 inside the handle 422, thereby securing the lever 420 to the anchor lock 415 via the stem 412. Specifically, the stem 412 is formed from four rigid members 418 and the portion 427 is shaped to fit between the rigid members 418.

When connected to the anchor 410, the anchor base 404 is disposed between the lever 420 and the anchor lock 415. With the lever 420 disposed to one side of the anchor base 404 and the anchor lock 415 disposed on the other side of the anchor base 404, the anchor 410 is connected through the base aperture 405 by inserting the anchor stem 412 through the base aperture 405 and into one side of the passage 423 of the handle portion 422. The lever insert 426 is then inserted into an other side of the passage 423, the end portion 427 being push fit between the rigid members 418 of the stem 412. In order to maintain connection of the lever 420 to the anchor lock 415, the lever insert 426 also includes two clips 428 to secure the lever insert 426 to the handle portion 422. It is further noted that the rigid members 418 include hook end portions 419. These hook end portions 419 pass through the passage 423 and abut an edge (not shown) in the handle 422, preventing removal of the stem 412 from the handle 422.

By the present embodiment, the anchor 410 further includes an indicator washer 430 disposed between the lever 420 and the anchor lock 415, and more specifically between the lever 420 and the anchor base 404. The indicator washer 430 provides a visual indication to the user of the system 400 that the anchor 410 (i.e. the anchor lock 415) is in the locked position or in the unlocked position (or generally not locked when not connected to the anchor fixture 480). The indicator washer 430 includes a washer body 432 and a washer stop 434 extending from the washer body 432. The washer body 432 has a central aperture 436 defined therein, through which the stem 412 extends to engage with the lever 420. The washer body 432 is generally dome shaped, such that it resists compression from the convex surface of the washer body 432. In at least some embodiments, the dome formed body 432 provides a longitudinally outward directed force, against which the hook end portions 419 of the stem 412 abutting the handle 422 resist. These counter acting forces thus act to maintain a rigid alignment of the anchor 410. The washer stop 434 extends from the washer body 432 parallel to the anchor stem 512, generally toward the anchor lock 415. Use of the washer stop 434 will be described in more detail below. The indicator washer 430 includes at least one visual indicator for providing a visual indication of a locking status of the anchor 410 to a user. In the present embodiment, the indicator washer 430 includes both a locked-status indicator symbol 435 and an unlocked-status indicator symbol 437. In some embodiments, the indicator washer 430 could include only one of the indicator symbols 435, 437, or a different indicator. The washer body 432 also has formed therein two pairs of indents 431 (FIG. 43), each pair of indents 431 being aligned with one of the indicator symbols 435, 437. Two oppositely disposed bumps 425 of the handle 222 (FIG. 44), positioned on a side adjacent the indicator washer 430, are received in the indents 431 when the anchor lock 415 and the lever 420 are in the locked or unlocked positions. When received in the indents 431, the bumps 425 aid in indicating that the lever 420 is in the correct position, i.e. the lever 420 clicks into place when the anchor lock 415 is in the locked or unlocked position.

The anchor 410 further includes a lock washer 440 disposed between the base aperture 405 of the anchor base 404 and the anchor lock 415. The lock washer 440 is thus oppositely disposed to the indicator washer 430 (relative to the base aperture 405) and acts as a stabilizing feature to aid in maintaining the correct positioning of the anchor 410 relative to the anchor base 404 (or the accessory portion defining an aperture in embodiments omitting the anchor base 404). The lock washer 440 could be omitted in some embodiments.

The lock washer 440 has defined therein a central aperture 442 through which extends the anchor stem 412 for connecting with the lever 420. The lock washer 440 also has defined therein a channel 444, the channel 444 having the form of an arc centered on the axis 413. The washer stop 434 of the indicator washer 430 extends through the channel 444, with the channel 444 being sized and shaped to permit movement of the washer stop 434 relative to the lock washer 440. Relative motion of the different components of the anchor 410 during use is described in more detail below. The lock washer 440 also includes a plurality of teeth 446 disposed on a lever-facing surface thereof. The teeth 446 are shaped and arranged to engage with the slots 424 of the lever 420 (specifically of the handle 422). The lock washer 440 is thus rotationally fixed to the lever 420.

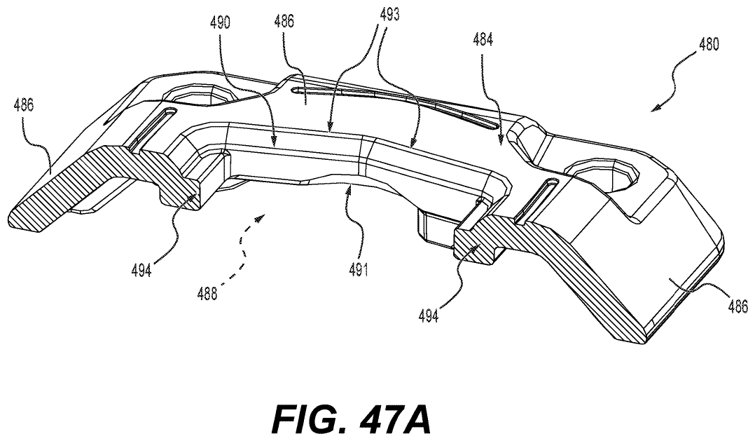

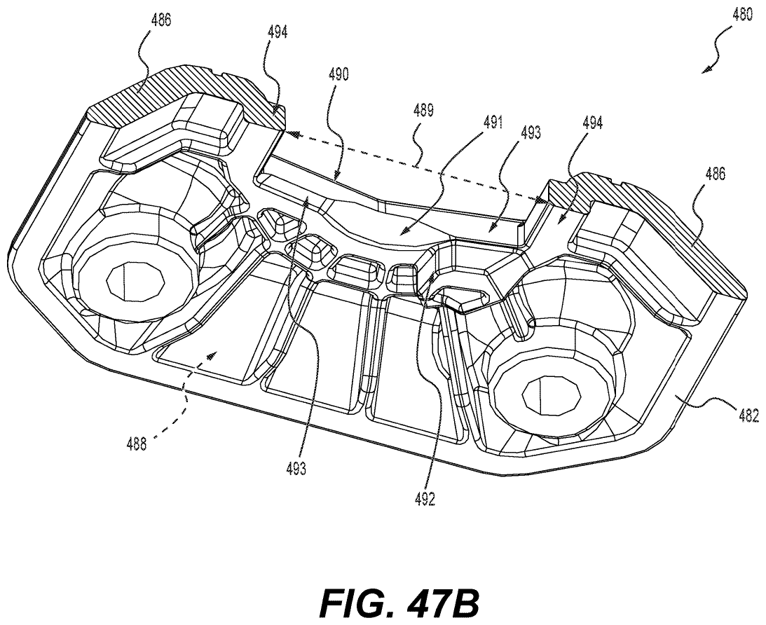

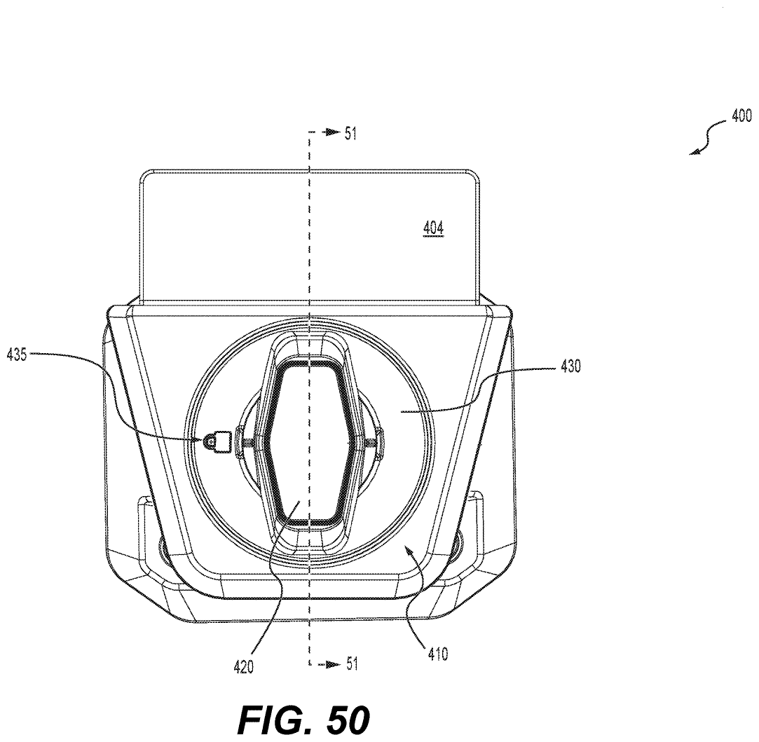

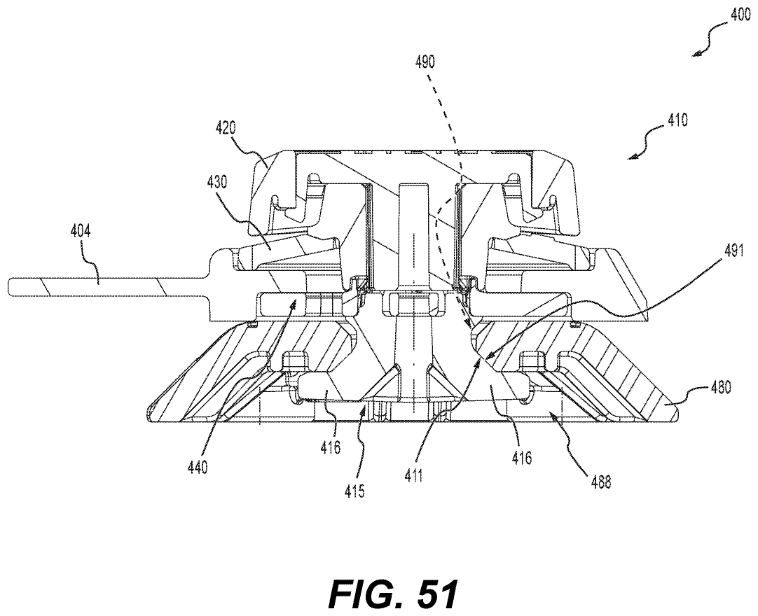

The system 400 also includes an anchor fixture 480 that is fixable to an item, such as the snowmobile 10 or the garment 10′, the anchor 410 being mateable with the anchor fixture 480. With additional reference to FIGS. 46A,B and 47A,B, the anchor fixture 480 has a fixture body 482 including a top wall portion 482 and four side wall portions 486. Each of the wall portions 484, 486 has an interior surface and an exterior surface. The interior surfaces of the wall portions 484, 486 define an anchor chamber 488 that is configured to receive therein the anchor lock 415. The top wall portion 484 also defines an anchor aperture 490 that opens into the anchor chamber 488. The anchor lock 415 is selectively inserted into the anchor chamber 488 through the anchor aperture 490 in order to secure the anchor 410 to the anchor fixture 480. The anchor lock 415 is illustrated disposed in the anchor chamber 488 in the unlocked position in FIG. 48 and in the locked position in FIG. 49.

As can be seen from FIG. 46A, the anchor aperture 490 is a hexagonal aperture 490 in the present embodiment. The hexagonal aperture 490 is defined by two shorter end side portions 494 and four longer longitudinal side portions 493. Each of the two end side portions 494 are shorter than each of the four longitudinal side portions 493. A major axis 489 of the anchor aperture 490 is defined by a line 489 extending between the two end side portions 494 and a minor axis 487 of the anchor aperture 490 is defined by a line 487 extending between junctions of each pair of the longitudinal side portions 494. The major axis 489 is larger than the minor axis 487, such that the anchor aperture 490 has a generally oblong, hexagonal form. It is contemplated that the shape of the anchor aperture 490 could vary in different embodiments.

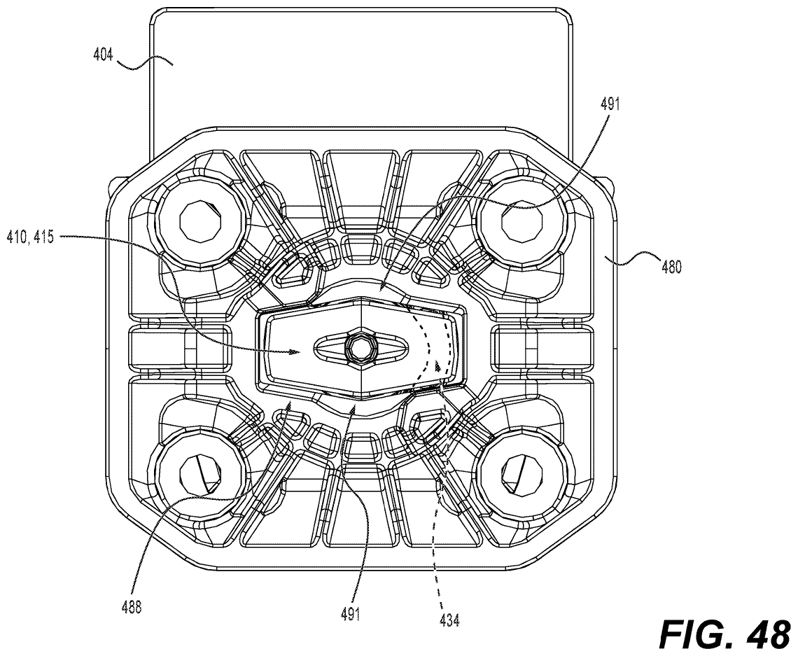

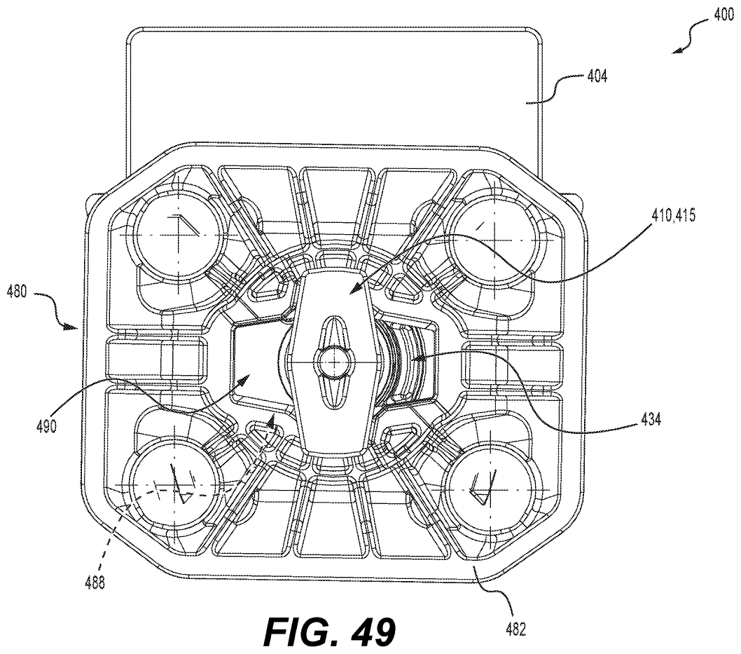

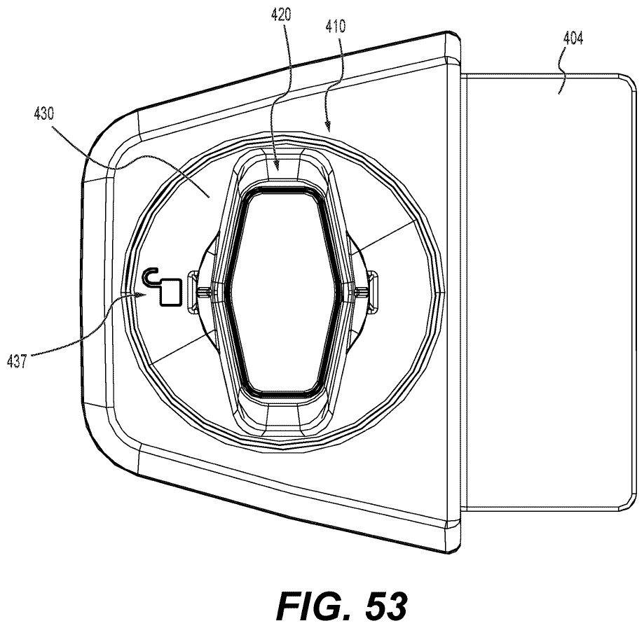

Returning to FIGS. 46B to 47B, the anchor aperture 490 has one or more recessed portions 491 formed along an edge thereof. Specifically, two side wall portions 486 defining the long sides of the aperture 490 further form two oppositely disposed recessed portions 491, along the fixture body 482, along the surface between the top wall portion 484 and the chamber 488. The recessed portions 491 are generally centered between longer of the longer side portions 493 on each side of the anchor aperture 490. The recessed portions 491 are generally arc-shaped recesses 491 formed by the anchor fixture 480. With reference to FIGS. 49 to 51, when the anchor lock 415 is in the locked position, the protrusions 411 of the anchor lock 415 are received in the recessed portions 491 of the anchor aperture 490. The anchor lock 415, by way of the protrusions 411 nested in the recessed portions 491, thus impedes movement of the anchor 410 within the anchor fixture 480. In the present embodiment, lateral movement of the anchor lock 415, orthogonal to a line passing through a center of the cams 416 and along a long axis of the anchor aperture 490, is generally reduced. Otherwise stated, the anchor lock is shaped and arranged to impede movement along the major axis 489 and the minor axis 487 of the anchor aperture 487, such that lateral movement of the anchor 410 is reduced parallel and orthogonal to the anchor aperture 490.

Depending on the relative shapes and arrangements of the protrusions 411 and recessed portions 491, it is also contemplated that incidental rotational movement of the anchor lock 415 away from the locked position may be reduced or impeded. The anchor aperture 490 has stop edge portions 492 formed adjacent to the recessed portions 491, formed by the fixture body 482 on the bottom side thereof. As will be noted below, the stop edge portions 492 aid in preventing the anchor lock 415 from being turned past the locked position.

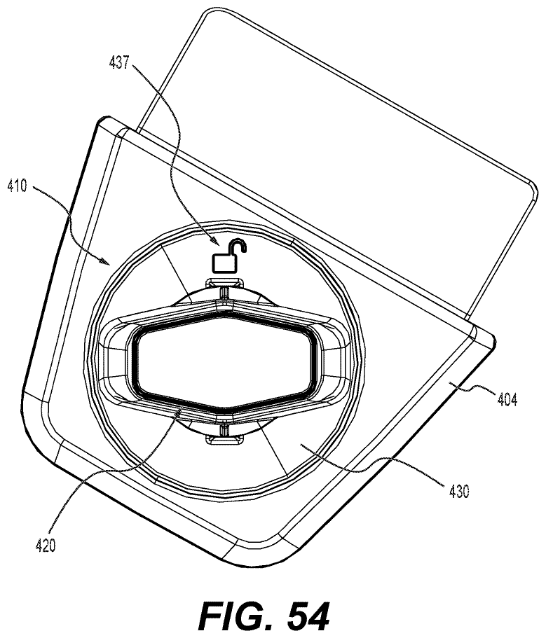

Returning to FIGS. 49 to 51 and with additional reference to FIGS. 52 to 54, the washer stop 434 of the anchor 410 aids in properly indicating locked and unlocked status of the system 400 when in use, while also providing a flexible orientation of the anchor 410 relative to the corresponding anchor fixture 480.

As can be seen from at least FIG. 44, the anchor 410 is connected to the anchor base 404 by the stem 412 extending through the base aperture 405, but is not otherwise fastened to the anchor base 404. The entirety of the anchor 410 is thus rotatable relative to the anchor base 404 when the anchor 410 is not engaged with the anchor fixture. As can be seen in FIGS. 52 to 54, the anchor 410 is rotatable to a variety of orientations relative to the anchor base 404. This permits the anchor 410 to be oriented to match a variety of orientations of anchor fixtures 480, without requiring a change in the connection between the anchor 410 and the accessory to which it is connected or requiring to change the orientation of the anchor fixture 480. When the anchor 410 is separated and spaced from the anchor fixture 480, the lever 420, the anchor lock 415, and the indicator washer 430 are rotatable relative to the base aperture 405. As there is no component acting on the indicator washer 430, an indication that the anchor lock 415 is unlocked, via the indication symbol 437, remains visible to correctly indicate the unlocked status.

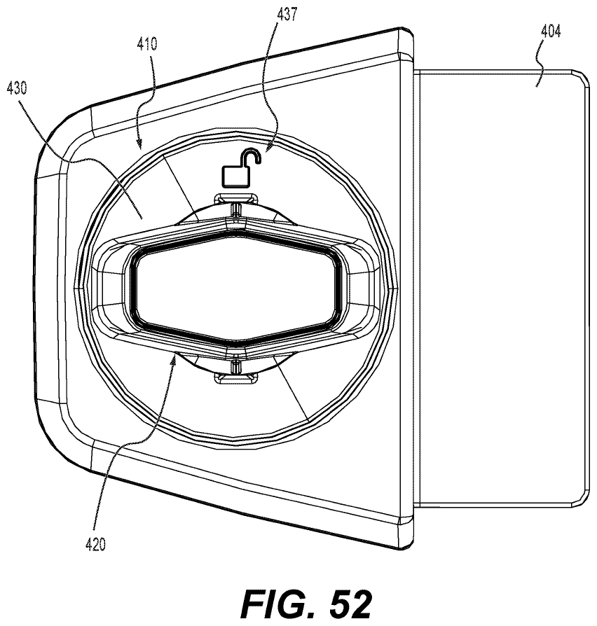

When the anchor 410 is in the unlocked position, the anchor lock 415 is free to pass through the anchor aperture 490. Upon inserting the anchor lock 415 into the anchor aperture 490, the washer stop 434 is received in the anchor aperture 490; see for example FIGS. 48, 49. Rotational movement of the indicator washer 430 is then impeded by the anchor fixture 480, as the washer stop 434 abuts the edge of the anchor aperture 490 when the anchor 410 is rotated to move to the locked position. Thus when the washer stop 434 is received in the anchor aperture 490, the lever 420 and the anchor lock 415 are rotatable relative to the indicator washer 430, the base aperture 405, and the anchor fixture 480. Upon rotation of the lever 420 to move the anchor lock 415 to the locked position, the lever 420 now also moves relative to the indicator washer 430, which in turn results in the lever 420 hiding the unlocked indication symbol 437 and displays the locked indication symbol 435 (see FIG. 50).

As is mentioned above, the lock washer 440 is also rotationally fixed to the lever 420. The lock washer 440 thus rotates relative to the indicator washer 430 when the washer stop 434 is received in the anchor aperture 490, with the washer stop 434 extending through the channel 444 of the lock washer 440. As the channel 444 extends only a quarter-turn around the axis 413, motion of the anchor lock 415 is limited to a quarter-turn. At the maximum unlocked position, the lever 420 will be impeded from turning further away from the locked position by the end of the channel 444 abutting the washer stop 434, which in turn is prevented from rotating by the anchor aperture 490. From the maximum locked position, the lever 420 will be impeded from turning further away from the unlocked position by the opposite end of the channel 444 abutting the washer stop 434, which in turn is again prevented from rotating by the anchor aperture 490. The stop edge portions 492 adjacent to the recessed portions 491 further aid in preventing the anchor lock 415 from being over-rotated past the locked position. When attempting to turn beyond the locked position, the anchor lock 415 abuts the two oppositely disposed stop edge portions 492.

The systems and anchors described above and implemented in accordance with some non-limiting implementations of the present technology can be represented as presented in the following numbered clauses.

CLAUSE 1. A system for connecting an accessory to an item, the system comprising: an anchor fixture comprising: a fixture body configured to be connected to one of the accessory and the item, the fixture body defining an anchor aperture therein, the anchor aperture having at least one recessed portion along an edge thereof; an anchor configured to be connected to an other one of the accessory and the item, the anchor including: an anchor lock being configured to be inserted through the anchor aperture of the anchor fixture, the anchor lock having at least one protrusion extending therefrom, the anchor lock being movable relative to the anchor fixture between an unlocked position and a locked position, in the unlocked position, the anchor lock being free to pass through the anchor aperture, and in the locked position: the anchor lock being prevented by the anchor fixture from passing through the anchor aperture, and the at least one protrusion of the anchor lock being received in the at least one recessed portion of the anchor aperture; and the anchor being selectively secured to the anchor fixture by inserting the anchor lock through the anchor aperture and moving the anchor lock relative to the anchor fixture to place the anchor lock in the locked position, the anchor lock impeding movement within the anchor fixture of the anchor.

CLAUSE 2. The system of clause 1, wherein the anchor comprises: an anchor stem, and an anchor lock connected to a first end of the anchor stem; and a lever connected to a second end of the anchor stem, the lever being rotatable to cause the anchor lock to rotate between the unlocked position and the locked position.

CLAUSE 3. The system of clause 1 or 2, further comprising: an anchor base configured to be connected to the other one of the accessory and the item; the anchor base defines a base aperture therein; the anchor is rotationally connected to the anchor base, a portion of the anchor extending through the base aperture; and the anchor base is disposed between the lever and the anchor lock.

CLAUSE 4. The system of clause 3, further comprising: an anchor base configured to be connected to the other one of the accessory and the item; the anchor base defines a base aperture therein; and wherein: the lever includes: a handle portion having a passage defined therethrough, and a lever insert selectively disposed at least partially in the passage; the second end of the anchor stem is shaped to engage with an end portion of the lever insert; and the anchor being connected through the base aperture by: inserting the anchor stem through the base aperture and into one side of the passage of the handle portion, and inserting the lever insert into an other side of the passage.

CLAUSE 5. The system of clause 4, wherein the lever insert comprises clips for maintaining connection of the lever insert, the handle portion, and the anchor stem.

CLAUSE 6. The system of clause 4 or 5, wherein: the anchor further comprises an indicator washer disposed between the lever and the anchor lock; and the indicator washer includes: a washer body, and a washer stop extending from the washer body, the washer stop extending parallel to the anchor stem.

CLAUSE 7. The system of clause 6, wherein: when the anchor is separated and spaced from the anchor fixture: the lever, the anchor lock, and the indicator washer are rotatable relative to a base aperture defined by one of an anchor base and the one of the accessory and the item; and when the anchor lock is inserted into the anchor aperture: the washer stop is received in the anchor aperture, rotational movement of the indicator washer being impeded by the anchor fixture, the washer stop abutting edges of the anchor aperture when the anchor is rotated, and the lever and the anchor lock are rotatable relative to the indicator washer, the base aperture, and the anchor fixture.

CLAUSE 8. The system of clause 7, wherein the indicator washer includes at least one visual indicator, the at least one visual indicator providing a visual indication of a locking status of the anchor to a user.

CLAUSE 9. The system of clause 7 or 8, wherein: the anchor further comprises a lock washer disposed between the base aperture and the anchor lock; and the indicator washer is disposed between the lever and the base aperture.

CLAUSE 10. The system of clause 9, wherein: the lock washer has defined therein: a channel, and a central aperture; the anchor stem extends through the central aperture; the washer stop extends through the channel, the channel being sized and shaped to permit movement of the washer stop relative to the lock washer; and when the anchor lock is inserted into the anchor aperture: the lock washer rotates relative to the indicator washer.

CLAUSE 11. The system of clause 9 or 10, wherein: the lever has a plurality of slots defined therein; and the lock washer comprises a plurality of teeth disposed on one surface thereof, the plurality of teeth being shaped and arranged to engage with the plurality of slots of the lever.

CLAUSE 12. The system of any one of clauses 1 to 11, wherein the at least one recessed portion of the anchor fixture is at least one arc-shaped recess formed by the anchor fixture.

CLAUSE 13. The system of any one of clauses 1 to 12, wherein: the at least one recessed portion of the anchor fixture includes two oppositely disposed recessed portions; the at least one protrusion of the anchor lock includes two oppositely disposed protrusions formed by the anchor lock; and each protrusion is received in a corresponding one of the recessed portions when the anchor lock is in the locked position.

CLAUSE 14. The system of clause 13, wherein: the anchor lock comprises two cams extending from opposite sides of the anchor stem; and each of the two protrusions is formed from a protruding surface extending from the anchor stem to a corresponding one of the two cams.

CLAUSE 15. The system of any one of clauses 1 to 14, wherein: the anchor aperture is a hexagonal aperture; the hexagonal aperture is defined by two end side portions and four longitudinal side portions; each of the two end side portions are shorter than each of the four longitudinal side portions; a line extending between the two end side portions defining a major axis of the anchor aperture; a line extending through a first junction of a first pair of the longitudinal side portions to a second junction of a second pair of the longitudinal side portions defining a minor axis of the anchor aperture; and the major axis is larger than the minor axis.

CLAUSE 16. The system of clause 15, wherein the anchor lock impedes movement along the major axis of the anchor aperture of the anchor within the anchor fixture.

CLAUSE 17. The system of clause 15, wherein the anchor lock impedes movement along the major axis and the minor axis of the anchor aperture of the anchor within the anchor fixture.

CLAUSE 18. The system of any one of clauses 1 to 17, wherein the anchor lock impedes lateral movement of the anchor within the anchor fixture.

CLAUSE 19. The system of clause 18, wherein the anchor lock impedes movement of the anchor: parallel to the anchor aperture; and orthogonal to the anchor aperture.

CLAUSE 20. An anchor for a system for connecting an accessory to an item, the anchor being configured to be connected to one of the accessory and the item, the anchor comprising: an anchor stem; an anchor lock connected to a first end of the anchor stem, the anchor lock being configured to be inserted through an anchor aperture of an anchor fixture, the anchor lock having at least one protrusion extending therefrom, the anchor lock being movable relative to the anchor fixture between an unlocked position and a locked position, in the unlocked position, the anchor lock being free to pass through the anchor aperture, and in the locked position: the anchor lock being prevented by the anchor fixture from passing through the anchor aperture, and the at least one protrusion of the anchor lock being received in a recessed portion of the anchor aperture; and the anchor being selectively secured to the anchor fixture by inserting the anchor lock through the anchor aperture and moving the anchor lock, the anchor lock impeding movement within the anchor fixture of the anchor.

CLAUSE 21. The anchor of clause 20, further comprising a lever connected to a second end of the anchor stem, the lever being rotatable to cause the anchor lock to rotate between the unlocked position and the locked position.

CLAUSE 22. The anchor of clause 20 or 21, wherein the at least one protrusion received in the at least one recessed portion impedes movement of the anchor within the anchor fixture.

CLAUSE 23. The anchor of any one of clauses 20 to 22, further comprising: an anchor base configured to be connected to the other one of the accessory and the item; the anchor base defines a base aperture therein; the anchor is rotationally connected to the anchor base, a portion of the anchor extending through the base aperture; and the anchor base is disposed between the lever and the anchor lock.

CLAUSE 24. The anchor of clause 21, wherein: the lever includes: a handle portion having a passage defined therethrough, and a lever insert selectively disposed at least partially in the passage; the second end of the anchor stem is shaped to engage with an end portion of the lever insert; and the anchor being connected through the base aperture by: inserting the anchor stem through the base aperture and into one side of the passage of the handle portion, and inserting the lever insert into an other side of the passage.

CLAUSE 25. The anchor of clause 24, wherein the lever insert comprises clips for maintaining connection of the lever insert, the handle portion, and the anchor stem.

CLAUSE 26. The anchor of any one of clauses 21 to 24, wherein: the anchor further comprises an indicator washer disposed between the lever and the anchor lock; and the indicator washer includes: a washer body, and a washer stop extending from the washer body, the washer stop extending parallel to the anchor stem.

CLAUSE 27. The anchor of clause 26, wherein when the anchor is separated and spaced from the anchor fixture: the lever, the anchor lock, and the indicator washer are rotatable relative to a base aperture defined by one of an anchor base and the one of the accessory and the item; and when the anchor lock is inserted into the anchor aperture: the washer stop is received in the anchor aperture, rotational movement of the indicator washer being impeded by the anchor fixture, the washer stop abutting edges of the anchor aperture when the anchor is rotated, and the lever and the anchor lock are rotatable relative to the indicator washer, the base aperture, and the anchor fixture.

CLAUSE 28. The anchor of clause 26 or 27, wherein the indicator washer includes at least one visual indicator, the at least one visual indicator providing a visual indication of a locking status of the anchor to a user.

CLAUSE 29. The anchor of any one of clauses 26 to 28, wherein: the anchor further comprises a lock washer disposed between the base aperture and the anchor lock; and the indicator washer is disposed between the lever and the base aperture.

CLAUSE 30. The anchor of clause 29, wherein: the lock washer has defined therein: a channel, and a central aperture; the anchor stem extends through the central aperture; the washer stop extends through the channel, the channel being sized and shaped to permit movement of the washer stop relative to the lock washer; and when the anchor lock is inserted into the anchor aperture: the lock washer rotates relative to the indicator washer.

CLAUSE 31. The anchor of clause 29 or 30, wherein: the lever has a plurality of slots defined therein; and the lock washer comprises a plurality of teeth disposed on one surface thereof, the plurality of teeth being shaped and arranged to engage with the plurality of slots of the lever.

CLAUSE 32. The anchor of any one of clauses 21 to 31, wherein: the at least one protrusion of the anchor lock includes two oppositely disposed protrusions formed by the anchor lock; and each protrusion is received in a corresponding one of a plurality of recessed portions of the anchor aperture when the anchor lock is in the locked position.

CLAUSE 33. The anchor of clause 32, wherein: the anchor lock comprises two cams extending from opposite sides of the anchor stem; and each of the two protrusions is formed from a protruding surface extending from the anchor stem to a corresponding one of the two cams.

CLAUSE 34. A system for connecting an accessory to an item, the system comprising: a first anchor fixture configured to be connected to the item, the first anchor fixture defining a first anchor chamber and a first anchor aperture opening into the first anchor chamber; a second anchor fixture configured to be connected to the item, the second anchor fixture defining a second anchor chamber and a second anchor aperture opening into the second anchor chamber; and an attachment base comprising: a base body configured to be connected to the accessory; a snap joint attached to the base body at a first end portion of the base body, the snap joint being shaped and adapted for selectively inserting into the first anchor aperture; and an anchor lock attached to the base body at a second end portion of the base body opposite the first end portion, the anchor lock being selectively inserted into the second anchor aperture, the anchor lock, when inserted into the second anchor aperture, being rotatable relative to the second anchor fixture between an unlocked position and a locked position, in the locked position: the anchor lock being disposed in the second anchor chamber and being prevented by the second anchor fixture from passing through the second anchor aperture, and the snap joint being generally aligned with the first anchor aperture of the first anchor fixture to be selectively inserted into the first anchor aperture, in the unlocked position: the anchor lock being free to pass through the second anchor aperture, and the snap joint being misaligned with the first anchor fixture, an entirety of the attachment base being rotated with the anchor lock to move the anchor lock between the unlocked position and the locked position.

CLAUSE 35. The system of clause 34, wherein the snap joint is a U-shaped snap fit joint, the U-shaped snap fit joint including: a U-shaped body shaped and arranged to be inserted into the anchor aperture, a first end of the U-shaped body being connected to the base body; the U-shaped body having a ridge on an exterior side of the U-shaped body; and a tab connected to and extending from a second end of the U-shaped body.

CLAUSE 36. The system of clause 35, wherein when the U-shaped snap fit joint is inserted into the first anchor aperture, a top edge of the ridge abuts an edge of the first anchor aperture to selectively maintain the U-shaped snap fit joint in the first anchor fixture; and the U-shaped snap fit joint is selectively removed from the first anchor aperture by using the tab to bend the second end of the U-shaped body toward the first end of the U-shaped body, thereby permitting the ridge to pass the edge of the first anchor aperture.

CLAUSE 37. The system of any one of clauses 34 to 36, wherein the base body is at least partially flexible, the base body flexing to permit the snap joint to be selectively inserted into and removed from the first anchor aperture when the anchor lock is in the locked position.

CLAUSE 38. The system of any one of clauses 34 to 37, wherein: when in the unlocked position, a long axis of the attachment base is positioned perpendicular to a line extending through centers of the first and second anchor apertures of the first and second anchor fixtures; and when in the locked position, the long axis of the attachment base is positioned parallel to the line extending through the centers of the first and second anchor apertures of the first and second anchor fixtures.

CLAUSE 39. The system of any one of clauses 34 to 38, wherein the base body and the snap joint are integrally formed.

CLAUSE 40. The system of any one of clauses 34 to 39, wherein the base body, the anchor lock, and the snap joint are integrally formed.

CLAUSE 41. The system of any one of clauses 34 to 40, wherein the attachment base further comprises a stem extending from the base body, the anchor lock extending from the stem.

CLAUSE 42. The system of clause 41, wherein the anchor lock comprises two cams extending from opposite sides of the stem.

CLAUSE 43. An attachment base for connecting an accessory to an item, an attachment base comprising: a base body configured to be connected to the accessory; a snap joint attached to the base body at a first end portion of the base body, the snap joint being shaped and adapted for inserting into a first anchor aperture of a first anchor fixture connected to the item; and an anchor lock attached to the base body at a second end portion of the base body opposite the first end portion, the anchor lock being adapted for inserting into a second anchor aperture of a second anchor fixture connected to the item, the anchor lock being rotatable relative to the second anchor fixture between an unlocked position and a locked position, in the locked position: the anchor lock being disposed in the second anchor chamber and being prevented by the second anchor fixture from passing through the second anchor aperture, and the snap joint being aligned with the first anchor aperture of the first anchor fixture to be selectively inserted into the first anchor aperture, in the unlocked position: the anchor lock being free to pass through the second anchor aperture, and the snap joint being misaligned with the first anchor fixture, an entirety of the attachment base being rotated with the anchor lock to move the anchor lock between the unlocked position and the locked position.

CLAUSE 44. The attachment base of clause 43, further comprising a stem extending from the base body, the anchor lock extending from the stem.

CLAUSE 45. The attachment base of clause 44, wherein the anchor lock comprises two cams extending from opposite sides of the stem.

CLAUSE 46. The attachment base of any one of clauses 43 to 45, wherein the snap joint is a U-shaped snap fit joint, the U-shaped snap fit joint including: a U-shaped body shaped and arranged to be inserted into the anchor aperture, a first end of the U-shaped body being connected to the base body; the U-shapes body having a ridge on an exterior side of the U-shaped body; and a tab connected to and extending from a second end of the U-shaped body.

CLAUSE 47. The attachment base of clause 46, wherein: when the U-shaped snap fit joint is inserted into the first anchor aperture, a top edge of the ridge abuts an edge of the anchor aperture to selectively maintain the U-shaped snap fit joint in the first anchor fixture; and the U-shaped snap fit joint is selectively removed from the first anchor aperture by using the tab to bend the second end of the U-shaped body toward the first end of the U-shaped body, thereby permitting the ridge to pass the edge of the first anchor aperture.

CLAUSE 48. The attachment base of any one of clauses 43 to 47, wherein the base body is at least partially flexible, the base body flexing to permit the snap joint to be selectively inserted into and removed from the first anchor aperture when the anchor lock is in the locked position.

CLAUSE 49. The attachment base of any one of clauses 43 to 48, wherein the base body and the snap joint are integrally formed.

CLAUSE 50. The attachment base of any one of clauses 43 to 49, wherein the base body, the anchor lock, and the snap joint are integrally formed.

CLAUSE 51. A method for connecting an accessory to an item, the method comprising: inserting an anchor lock of an attachment base connected to the accessory into a first anchor aperture of a first anchor fixture connected to the item; rotating the attachment base to rotate the anchor lock into a locked position; and inserting a snap joint of the attachment base into a second anchor aperture of a second anchor fixture connected to the item

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A system for connecting an accessory to an item, the system comprising:
an anchor fixture comprising:
a fixture body configured to be connected to one of the accessory and the item, the fixture body defining an anchor aperture therein,
the anchor aperture having at least one recessed portion along an edge thereof;
an anchor configured to be connected to an other one of the accessory and the item, the anchor including:
an anchor lock being configured to be inserted through the anchor aperture of the anchor fixture,
the anchor lock having at least one protrusion extending therefrom, the anchor lock being movable relative to the anchor fixture between an unlocked position and a locked position,
in the unlocked position, the anchor lock being free to pass through the anchor aperture, and
in the locked position:
the anchor lock being prevented by the anchor fixture from passing through the anchor aperture, and
the at least one protrusion of the anchor lock being received in the at least one recessed portion of the anchor aperture; and
the anchor being selectively secured to the anchor fixture by inserting the anchor lock through the anchor aperture and moving the anchor lock relative to the anchor fixture to place the anchor lock in the locked position,
the anchor lock impeding movement within the anchor fixture of the anchor.

2. The system of claim 1, wherein:
the anchor comprises:
an anchor stem, and
an anchor lock connected to a first end of the anchor stem; and
a lever connected to a second end of the anchor stem, the lever being rotatable to cause the anchor lock to rotate between the unlocked position and the locked position.

3. The system of claim 1, further comprising:
an anchor base configured to be connected to the other one of the accessory and the item;
the anchor base defines a base aperture therein;
the anchor is rotationally connected to the anchor base, a portion of the anchor extending through the base aperture; and
the anchor base is disposed between the lever and the anchor lock.

4. The system of claim 3,
wherein:
the lever includes:
a handle portion having a passage defined therethrough, and
a lever insert selectively disposed at least partially in the passage;
the second end of the anchor stem is shaped to engage with an end portion of the lever insert; and
the anchor being connected through the base aperture by:
inserting the anchor stem through the base aperture and into one side of the passage of the handle portion, and
inserting the lever insert into an other side of the passage.

5. (canceled)

6. The system of claim 4, wherein:
the anchor further comprises an indicator washer disposed between the lever and the anchor lock; and
the indicator washer includes:
a washer body, and
a washer stop extending from the washer body, the washer stop extending parallel to the anchor stem.

7. The system of claim 6, wherein:
when the anchor is separated and spaced from the anchor fixture:
the lever, the anchor lock, and the indicator washer are rotatable relative to a base aperture defined by one of an anchor base and the one of the accessory and the item; and
when the anchor lock is inserted into the anchor aperture:
the washer stop is received in the anchor aperture, rotational movement of the indicator washer being impeded by the anchor fixture, the washer stop abutting edges of the anchor aperture when the anchor is rotated, and
the lever and the anchor lock are rotatable relative to the indicator washer, the base aperture, and the anchor fixture.

8. (canceled)

9. The system of claim 7, wherein:
the anchor further comprises a lock washer disposed between the base aperture and the anchor lock; and
the indicator washer is disposed between the lever and the base aperture.

10. The system of claim 9, wherein:
the lock washer has defined therein:
a channel, and
a central aperture;
the anchor stem extends through the central aperture;
the washer stop extends through the channel, the channel being sized and shaped to permit movement of the washer stop relative to the lock washer; and
when the anchor lock is inserted into the anchor aperture:
the lock washer rotates relative to the indicator washer.

11. (canceled)

12. The system of claim 1, wherein the at least one recessed portion of the anchor fixture is at least one arc-shaped recess formed by the anchor fixture.

13. The system of claim 1, wherein:
the at least one recessed portion of the anchor fixture includes two oppositely disposed recessed portions;
the at least one protrusion of the anchor lock includes two oppositely disposed protrusions formed by the anchor lock;
each protrusion is received in a corresponding one of the recessed portions when the anchor lock is in the locked position;
the anchor lock comprises two cams extending from opposite sides of the anchor stem; and
each of the two protrusions is formed from a protruding surface extending from the anchor stem to a corresponding one of the two cams.

14. (canceled)

15. The system of claim 1, wherein:
the anchor aperture is a hexagonal aperture;
the hexagonal aperture is defined by two end side portions and four longitudinal side portions;
each of the two end side portions are shorter than each of the four longitudinal side portions;
a line extending between the two end side portions defining a major axis of the anchor aperture;
a line extending through a first junction of a first pair of the longitudinal side portions to a second junction of a second pair of the longitudinal side portions defining a minor axis of the anchor aperture; and
the major axis is larger than the minor axis.

16-18. (canceled)

19. The system of claim 1, wherein;
the anchor lock impedes lateral movement of the anchor within the anchor fixture; and
the anchor lock impedes movement of the anchor:
parallel to the anchor aperture; and
orthogonal to the anchor aperture.

20. An anchor for a system for connecting an accessory to an item, the anchor being configured to be connected to one of the accessory and the item, the anchor comprising:
an anchor stem;
an anchor lock connected to a first end of the anchor stem, the anchor lock being configured to be inserted through an anchor aperture of an anchor fixture,
the anchor lock having at least one protrusion extending therefrom,
the anchor lock being movable relative to the anchor fixture between an unlocked position and a locked position,
in the unlocked position, the anchor lock being free to pass through the anchor aperture, and
in the locked position:
the anchor lock being prevented by the anchor fixture from passing through the anchor aperture, and
the at least one protrusion of the anchor lock being received in a recessed portion of the anchor aperture; and
the anchor being selectively secured to the anchor fixture by inserting the anchor lock through the anchor aperture and moving the anchor lock,
the anchor lock impeding movement within the anchor fixture of the anchor.

21. The anchor of claim 20, further comprising a lever connected to a second end of the anchor stem, the lever being rotatable to cause the anchor lock to rotate between the unlocked position and the locked position.

22. (canceled)

23. The anchor of claim 20, further comprising:
an anchor base configured to be connected to the other one of the accessory and the item;
the anchor base defines a base aperture therein;
the anchor is rotationally connected to the anchor base, a portion of the anchor extending through the base aperture; and
the anchor base is disposed between the lever and the anchor lock.

24. The anchor of claim 21, wherein:
the lever includes:
a handle portion having a passage defined therethrough, and
a lever insert selectively disposed at least partially in the passage;
the second end of the anchor stem is shaped to engage with an end portion of the lever insert; and
the anchor being connected through the base aperture by:
inserting the anchor stem through the base aperture and into one side of the passage of the handle portion, and
inserting the lever insert into an other side of the passage.

25. (canceled)

26. The anchor of claim 21, wherein:
the anchor further comprises an indicator washer disposed between the lever and the anchor lock; and
the indicator washer includes:
a washer body, and
a washer stop extending from the washer body, the washer stop extending parallel to the anchor stem.

27. The anchor of claim 26, wherein:
when the anchor is separated and spaced from the anchor fixture:
the lever, the anchor lock, and the indicator washer are rotatable relative to a base aperture defined by one of an anchor base and the one of the accessory and the item; and
when the anchor lock is inserted into the anchor aperture:
the washer stop is received in the anchor aperture, rotational movement of the indicator washer being impeded by the anchor fixture, the washer stop abutting edges of the anchor aperture when the anchor is rotated, and
the lever and the anchor lock are rotatable relative to the indicator washer, the base aperture, and the anchor fixture.

28. (canceled)

29. The anchor of claim 26, wherein:
the anchor further comprises a lock washer disposed between the base aperture and the anchor lock;
the indicator washer is disposed between the lever and the base aperture;
the lock washer has defined therein:
a channel, and
a central aperture;
the anchor stem extends through the central aperture;
the washer stop extends through the channel, the channel being sized and shaped to permit movement of the washer stop relative to the lock washer; and
when the anchor lock is inserted into the anchor aperture, the lock washer rotates relative to the indicator washer.

30-31. (canceled)

32. The anchor of claim 21, wherein:
the at least one protrusion of the anchor lock includes two oppositely disposed protrusions formed by the anchor lock;
each protrusion is received in a corresponding one of a plurality of recessed portions of the anchor aperture when the anchor lock is in the locked position;
the anchor lock comprises two cams extending from opposite sides of the anchor stem; and
each of the two protrusions is formed from a protruding surface extending from the anchor stem to a corresponding one of the two cams.

33-51. (canceled)
